(19) United States
(12) Patent Application Publication
(10) Pub. No.: US 2016/0200969 A1
(43) Pub. Date: Jul. 14, 2016

(54) STABILISED COMPOSITIONS CONTAINING ACRYLAMIDE POLYMERS, AND METHOD FOR THE TERTIARY PRODUCTION OF CRUDE OIL USING SAID COMPOSITIONS

(71) Applicant: BASF SE, Ludwigshafen (DE)

(72) Inventors: Roland REICHENBACH-KLINKE, Traunstein (DE); Kai-Uwe SCHÖNING, Oberwil (CH); Bruno ROTZINGER, Delémont (CH); Björn LANGLOTZ, Trostberg (DE)

(73) Assignee: BASF SE, Ludwigshafen (DE)

(21) Appl. No.: 14/912,991

(22) PCT Filed: Aug. 14, 2014
(86) PCT No.: PCT/EP2014/067444

§ 371 Date: Feb. 19, 2016

(30) Foreign Application Priority Data
Aug. 22, 2013 (EP) 13181338.8
Apr. 15, 2014 (EP) 14164734.7

(51) Int. Cl. C09K 8/88; E21B 43/16; C08K 5/3435

(52) U.S. Cl. CPC C09K 8/882; C08K 5/3435; E21B 43/16

(57) ABSTRACT

The present application relates to compositions comprising at least one acrylamide polymer P and at least one stabilizer S selected from sterically hindered amines; more particularly, the composition may be an aqueous solution comprising at least one acrylamide polymer P and at least one stabilizer S. In addition, the present invention relates to a process for producing the composition and to the use thereof in mineral oil production.

The present application relates to compositions comprising at least one acrylamide polymer P and at least one stabilizer S selected from sterically hindered amines; more particularly, the composition may be an aqueous solution comprising at least one acrylamide polymer P and at least one stabilizer S. In addition, the present invention relates to a process for producing the composition and to the use thereof in mineral oil production.

The present invention further relates to a process for mineral oil production, especially for tertiary mineral oil production, wherein an aqueous composition comprising at least one acrylamide polymer P and at least one stabilizer S is injected into an underground formation through at least one injection well and crude oil is withdrawn from the underground formation through at least one production well.

It is known that thickening water-soluble polymers can be used for tertiary mineral oil production, especially in what is called polymer flooding. The use of high molecular weight acrylamide polymers is widespread, these typically being poly(meth)acrylamide or poly(meth)acrylamide copolymers. For example, it is possible to use copolymers of (meth)acrylamide, acrylic acid and/or sulfo-functional monomers such as AMPS (2-acrylamido-2-methylpropane-1-sulfonic acid, H₂C═CH—CO—NH—C(CH₃)₂—CH₂—SO₃H). Additionally known is the use of what are called hydrophobically associating copolymers in the mineral oil production sector, especially for tertiary mineral oil production (enhanced oil recovery, EOR). These hydrophobically associating copolymers are described, for example, in WO 2010/133527. Details of the use of hydrophobically associating copolymers for tertiary mineral oil production are described, for example, in the review article by Taylor, K. C. and Nasr-El-Din. H. A. in J. Petr, Sci. Eng. 1998, 19, 265-280.

Polymer flooding involves injecting dilute aqueous polymer solutions through an injection well into a mineral oil-bearing underground formation. These polymer solutions flow into the formations in the direction of the production well. In the course of this, they force the mineral oil or natural gas and any formation water in the direction of the production well, such that a mixture of mineral oil or natural gas and formation water is produced through the production well. Processes for polymer flooding are described, for example, in WO 2010/13327 or WO 2012/069478.

The acrylamide polymers used in polymer flooding typically have a high molecular weight required to attain the desired thickening action. Typically, the molecular weight (M_{w}) is at least 10⁶ (1 million) g/mol, for example in the range from 1 to 30 million g/mol. Even minor polymer degradation distinctly reduces the molecular weight in such high molecular weight polymers.

This generally significantly lowers the viscosity of the polymer solution, which is extremely undesirable for use in tertiary mineral oil production (EOR).

The use of acrylamide polymers in polymer flooding places high demands on the stability of the polymers. Polymer flooding typically involves pumping aqueous polymer solutions through the underground rock formation over a period of up to several years. The temperature in these underground oil deposits covers a wide range and is characteristic of the specific deposit, and it is generally higher than the temperature at the surface of the earth. In order to assure the stability of the acrylamide polymers at elevated temperature and over a long period, it is normally necessary to add various stabilizers against the harmful influence of light, oxygen and heat. More particularly, oxygen scavengers, free-radical scavengers (for example thiourea, mercaptobenzothiazole (MBT) or sodium thiocyanate (NaSCN)), sacrificial reagents (e.g. alcohols such as 2-propanol, isopropanol), precipitants and complexing agents are used. The various stabilizers commonly used in tertiary mineral oil production are described, for example, in WO 2010/133258.

Free-radical scavengers are frequently used in combination with sacrificial reagents. In addition to the use of free-radical scavengers and sacrificial reagents, it is often additionally necessary to substantially exclude oxygen, which is achieved, for example, through the costly and inconvenient purging of the polymer solution with inert gas (such as N₂) and/or the addition of an oxygen scavenger (for example sodium bisulfite or hydrazine).

It has now been found that, surprisingly, when selected sterically hindered amines (HALS stabilizers) are used, especially the substance 1,2,2,6,6-pentamethyl-4-piperidinol (PMP), as a stabilizer, the costly and inconvenient inertization with nitrogen and the addition of an oxygen scavenger are unnecessary. It is possible to achieve advantageous stabilization of acrylamide polymer solutions, for example in polymer flooding, meaning that the high viscosity of the acrylamide polymer solutions needed for the polymer flooding can be maintained at elevated temperature (about 80° C.) and over a long period (more particularly over several weeks).

Sterically hindered piperidine derivatives, such as 2,2,6,6-tetramethyl-1-piperidine derivatives, and also the compound 1,2,2,6,6-pentamethyl-4-oiperidinol (PMP), are known as HALS stabilizers (hindered amine light stabilizers) and can be used as UV or light stabilizers. 1,2,2,6,6-Pentamethyl-4-piperidinol (PMP) and derivatives thereof are described, for example, in Xie et al., Macromolecular Chemistry and Physics (2012), 213(14), 1441-1447 and You et al., Colloids and Surfaces, A: Physicochemical and Engineering Aspects (2011), 392(1), 365-370). Frequently, PMP is used as a starting material for the synthesis of UV stabilizers, for example WO 2005070987.

WO 2012/157776 A1 discloses the use of 2,2,6,6-tetramethylpiperidine 1-oxide in combination with manganese ions for stabilization of aqueous acrylamide solutions, the intention being to prevent the polymerization of the acrylamide. CN 102382327 A discloses the use of cyclodextrin-modified, sterically hindered phenol derivatives for stabilization of polyacrylamide in oilfield applications.

The present invention relates to compositions comprising at least one acrylamide polymer P and at least one stabilizer S of the formula (I)

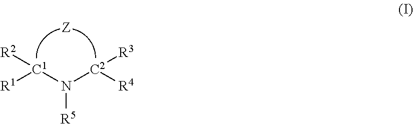

where the radicals are each defined as follows:
Z is a bivalent group comprising 2 to 5 atoms and/or groups selected from C(R⁶)₂, O, S, N—R′ and C═O, where the Z group together with the carbon atoms C¹, C² and the nitrogen atom N forms a 5- to 8-membered ring, where R′ is selected from H, alkyl, C₂₋₂₀-alkenyl, C₆₋₂₀-aryl, C₇₋₃₂-arylalkyl, C₁₋₂₀-hydroxyalkyl, C₁₋₂₀-aminoalkyl, C₁₋₂₀-cyanoalkyl, C₁₋₂₀-haloalkyl, C₁₋₂₀-sulfoalkyl and C₁₋₂₀-phosphonoalkyl;
   where R⁶ is independently selected from H; OH; CN; C₁₋₂₀-alkyl; C₂₋₂₀-alkenyl; C₂₋₂₀-alkynyl; C₆₋₂₀-aryl; C₇₋₃₂-arylalkyl; C₁₋₂₀-alkoxy; C₁₋₂₀-hydroxyalkyl; C₁₋₂₀-aminoalkyl; C₁₋₂₀-cyanoalkyl; C₁₋₂₀-haloalkyl; halogen; C₁₋₂₀-sulfoalkyl; C₁₋₂₀-phosphonoalkyl; —(CH₂—CH(R^{a})—O)_{q}—H with q=1-20 and R^{a}=H or C₁₋₆-alkyl; —O—C(═O)R^{b} with R^{b}=H, C₁₋₂₀-alkyl, C₂₋₂₀-alkenyl, C₂₋₂₀-alkynyl, C₆₋₂₀-aryl or C₇₋₃₂-arylalkyl; —O—C(═O)—(CH₂)ₘ—C(═O)—O—R^{c}; —O—C(═O)—Y—C(═O)—O—R^{c}, where m=1-10, R^{c}=H, C₁₋₂₀-alkyl, C₂₋₂₀-alkenyl, C₂₋₂₀-alkynyl, C₆₋₂₀-aryl, C₇₋₃₂-arylalkyl or 1,2,2,6,6-pentamethylpiperidin-4-yl and Y is a C₂₋₁₀-alkenylene group; —O—R^{d} with R^{d}=C₂₋₂₀-alkenyl, C₂₋₂₀-alkynyl, C₂₋₂₀-aryl, C₇₋₃₂-arylalkyl or 1,2,2,6,6-pentamethylpiperidin-4-yl; —NR^{x}R^{y}, —N(R^{x})—C(═O)R^{y}; —N(R^{x})—C(═O)—Y—C(═O)—O—R^{y}; —N(R^{x})—(CH₂)ᵣ—NR^{y}R^{z} where R^{x}, R^{y} and R^{z} are each independently H, C₁₋₂₀-alkyl, C₂₋₂₀-alkenyl, C₂₋₂₀-alkynyl, C₆₋₂₀-aryl, C₇₋₃₂-arylalkyl, C₁₋₂₀-hydroxyalkyl, C₁₋₂₀-aminoalkyl or 1,2,2,6,6-pentamethylpiperidin-4-yl, r=1-10 and Y is a C₂₋₁₀-alkenylene group; —(O—CH₂—CH(R^{e})—(CH₂)ᵢ)ₚ—O—R^{e′} with p=1-20, i=0 or 1, R^{e}=H, OH or C₁₋₆-alkyl and R^{e′}=H or C₁₋₈-alkyl; —S—R^{f}; —S—S—R^{f} with R^{f}=H, C₁₋₂₀-alkyl, C₂₋₂₀-alkenyl, C₆₋₂₀-aryl or C₇₋₃₂-arylalkyl;
   or where two R⁶ radicals together with the carbon atom to which they are bonded form a —C—(O—CH₂—CH₂—O)—, —C—(O—CH₂—CH₂—CH₂—O)—, —C—(O—C(CH₃)₂—C(CH₃)₂—O)— or —C—(NH—O(═O)—NH—O(═O))— ring;
R¹, R², R³ and R⁴
   are each independently selected from C₁₋₂₀-alkyl, C₂₋₂₀-alkenyl, C₆₋₂₀-aryl, C₇₋₃₂-arylalkyl, C₁₋₂₀-alkoxy, C₁₋₂₀-hydroxyalkyl, C₁₋₂₀-aminoalkyl or C₁₋₂₀-haloalkyl;
   or the R¹ and R² radicals together with C¹ or the R³ and R⁴ radicals together with C² form a ring which comprises 5 to 7 carbon atoms and which may optionally be substituted by one or more R⁶ groups;
R⁵ is H; C₁₋₂₀-alkyl; C₂₋₂₀-alkenyl; C₂₋₂₀-alkynyl; C₆₋₂₀-aryl; C₇₋₃₂-arylalkyl; C₁₋₂₀-alkoxy; C₄₋₈-cycloalkoxy; C₁₋₂₀-hydroxyalkyl; C₁₋₂₀-aminoalkyl; C₁₋₂₀-cyanoalkyl; C₁₋₂₀-haloalkyl; C₁₋₂₀-sulfoalkyl; C₁₋₂₀-phosphonoalkyl; —(CH₂—CH(R^{a})—O)_{q}—H with q=1-20 and R^{a}=H or C₁₋₆-alkyl; —O—C(═O)R^{b} with R^{b}=H, C₁₋₂₀-alkyl, C₂₋₂₀-alkenyl, C₂₋₂₀-alkynyl, C₆₋₂₀-aryl or C₇₋₃₂-arylalkyl; —O—C(═O)—(CH₂)ₘ—C(═O)—O—Re; —O—C(═O)—Y—C(═O)—O—R^{c}, where m=1-10, R^{c}=H, C₁₋₂₀-alkyl, C₂₋₂₀-alkenyl, C₂₋₂₀-alkynyl, C₆₋₂₀-aryl, C₇₋₃₂-arylalkyl or 1,2,2,6,6-pentamethylpiperidin-4-yl and Y is a C₂₋₁₀-alkenylene group; —O—R^{d} with R^{d}=C₂₋₂₀-alkenyl, C₂₋₂₀-alkynyl, C₆₋₂₀-aryl, C₇₋₃₂-arylalkyl or 1,2,2,6,6-pentamethylpiperidin-4-yl; —(O—CH₂—CH(R^{e})—(CH₂)ᵢ)ₚ—O—R^{e′} with p=1-20, i=0 or 1, R^{e}=H, OH or C₁₋₆-alkyl and R^{e′}=H or C₁₋₈-alkyl; —O(═O)—R^{h} with R^{h}=H, C₁₋₂₀-alkyl, C₂₋₂₀-alkenyl, C₆₋₂₀-aryl or C₇₋₂₀-arylalkyl; 2,2,6,6-tetramethyl-4-piperidinol-1-yl-alkyl or 4-(2,2,6,6-tetramethyl-4-piperidinol-1-ylalkyl)benzyl.

In the context of the present invention, these radicals are defined as follows:

Alkyl denotes a univalent radical consisting of a linear, branched or cyclic hydrocarbyl group, preferably of a linear or branched hydrocarbyl chain, especially comprising 1 to 20 carbon atoms, preferably 1 to 18 carbon atoms, more preferably 1 to 12 carbon atoms. For example, the alkyl radical may be methyl, ethyl, n-propyl or isopropyl.

Alkenyl denotes a univalent radical consisting of a linear or branched hydrocarbyl chain, especially comprising 2 to 20 carbon atoms, preferably 2 to 18 carbon atoms, more preferably 2 to 12 carbon atoms, which comprises one or more C—C double bonds, where the C—C double bonds may occur within the hydrocarbyl chain or at the end of the hydrocarbyl chain (terminal C═C double bond). For example, an alkenyl radical may be an allyl radical.

Alkynyl denotes a univalent radical consisting of a linear or branched hydrocarbyl chain, especially comprising 2 to 20 carbon atoms, preferably 2 to 18 carbon atoms, more preferably 2 to 12 carbon atoms, which comprises one or more C—C triple bonds, where the C—C triple bonds may occur within the hydrocarbyl chain or at the end of the hydrocarbyl chain (terminal C—C triple bond). For example, an alkynyl radical may be an ethynyl radical.

Aryl denotes a substituted or unsubstituted aromatic hydrocarbyl group, especially comprising 6 to 20 carbon atoms. For example, the aryl radical may be a phenyl group.

Arylalkyl denotes a univalent radical derived from a linear or branched alkyl radical, especially comprising 1 to 20 carbon atoms, preferably 2 to 18 carbon atoms, more preferably 2 to 12 carbon atoms, by the exchange of one or more hydrogen atoms for an aryl group, where the aryl group is a substituted or unsubstituted aromatic hydrocarbyl group, especially comprising 6 to 14 carbon atoms. For example, the aromatic hydrocarbyl group may be phenyl; for example, the arylalkyl radical may be a benzyl radical.

Alkyloxy denotes a univalent radical —O—R^{alkyl} where R^{alkyl} is a linear or branched alkyl radical, especially comprising 2 to 20 carbon atoms, preferably 2 to 18 carbon atoms, more preferably 2 to 12 carbon atoms. Cycloalkoxy denotes a univalent radical —O—R^{cycloalkyl} where R^{cycloalkyl} is a saturated cyclic hydrocarbyl group, especially comprising 4 to 8 carbon atoms.

Aminoalkyl denotes a univalent radical derived from a linear or branched alkyl radical, especially comprising 1 to 20 carbon atoms, preferably 2 to 18 carbon atoms, more preferably 2 to 12 carbon atoms, by the exchange of one or more hydrogen atoms for an amino group, where the amino group may be a primary, secondary or tertiary amino group. For example, the amino group may be a group selected from —NH₂; —NH(CH₃)₂ and —N(CH₃)₂.

Cyanoalkyl denotes a univalent radical derived from a linear or branched alkyl radical, especially comprising 2 to 20 carbon atoms, preferably 2 to 18 carbon atoms, more preferably 2 to 12 carbon atoms, by the exchange of one or more hydrogen atoms for a cyano group (—CN).

Sulfoalkyl denotes a univalent radical derived from a linear or branched alkyl radical, especially comprising 1 to 20 carbon atoms, preferably 2 to 18 carbon atoms, more preferably 2 to 12 carbon atoms, by the exchange of one or more hydrogen atoms for sulfo groups (—SO₃H) and/or salts thereof (SO₃⁻) and/or esters thereof (—S(═O)₂ORⁱ with Rⁱ=alkyl, alkenyl, aryl or arylalkyl), More particularly, sulfoalkyl denotes a -A-S(═O)₂—O—Rⁱⁱ group where A is a linear or branched C₁₋₁₀ alkylene group and Rⁱⁱ=hydrogen, a metal salt, C₁₋₁₈-alkyl, C₂₋₁₈-alkenyl, C₆₋₂₀-aryl or C₇₋₃₂-arylalkyl, especially C₁₋₁₈-alkyl, preferably C₁₋₁₀-alkyl.

Phosphonoalkyl denotes a univalent radical derived from a linear or branched alkyl radical, especially comprising 1 to 20 carbon atoms, preferably 2 to 18 carbon atoms, more preferably 2 to 12 carbon atoms, by the exchange of one or more hydrogen atoms for phosphonic acid groups (—PO(OH)₂) and/or salts thereof (—PO(O⁻)₂) and/or esters thereof (—PO(ORⁱ)₂ with Rⁱ=alkyl, alkenyl, aryl or arylalkyl). More particularly, phosphonoalkyl denotes a -A-P(═O)(ORⁱⁱ)₂ group where A is a linear or branched C₁₋₁₀ alkylene group and =hydrogen, a metal salt, C₁₋₁₈-alkyl, C₂₋₁₈-alkenyl, C₆₋₂₀-aryl or C₇₋₃₂-arylalkyl, especially C₁₋₁₈-alkyl, preferably C₁₋₁₀-alkyl.

Haloalkyl denotes a univalent radical derived from a linear or branched alkyl radical, especially comprising 2 to 20 carbon atoms, preferably 2 to 18 carbon atoms, more preferably 2 to 12 carbon atoms, by the exchange of one or more hydrogen atoms for a halogen atom (—F, —Cl, —Br, —I, especially Cl). Halogen denotes a substituent selected from fluoride, chloride, bromide and iodide, especially chloride.

Hydroxyalkyl denotes a univalent radical derived from a linear or branched alkyl radical, especially comprising 2 to 20 carbon atoms, preferably 2 to 18 carbon atoms, more preferably 2 to 12 carbon atoms, by the exchange of one or more hydrogen atoms for a hydroxyl group (—OH). The hydroxyalkyl group may preferably be a —CH₂—CH(R^{a})—OH group with R^{a}=H or C₁₋₁₂-alkyl.

### Acrylamide Polymer:

An acrylamide polymer in the context of the present invention is a polymer (homopolymer or copolymer) comprising at least one (meth)acrylamide. In the context of the present invention, the notation (meth)acrylamide is intended to encompass acrylamide and/or methacrylamide. More particularly, “acrylamide polymer” or “acrylamide polymer P” in the context of the present invention denotes a polymer comprising at least 10% by weight, preferably at least 15% by weight and especially preferably more than 45% by weight, more preferably more than 60% by weight, of (meth)acrylamide, based on the total amount of all the monomers in acrylamide polymer P. In the context of the present invention, a polymer comprising or containing a monomer is understood to mean a polymer comprising or containing a monomer unit (polymerized within the polymer chain) based on said monomer. The person skilled in the art is aware that, in the context of the invention, this wording does not describe a proportion of unreacted residual monomer.

In one embodiment of the invention, the acrylamide polymer P used may be a polymer comprising (or consisting essentially of) (meth)acrylamide.

In addition, the acrylamide polymer P used may be a copolymer comprising (or consisting of) (meth)acrylamide and at least one further monomer. More particularly, the acrylamide polymer P is a copolymer comprising, as well as (meth)acrylamide, an anionic monomer (acidic monomer) as a further monomer, especially selected from acrylic acid, vinylsulfonic acid and acrylamidomethylpropanesulfonic acid. As further monomers, it is also possible to use dimethylacrylamide or monomers comprising cationic groups.

In a preferred embodiment, the acrylamide polymer P is a copolymer comprising (meth)acrylamide and at least one anionic, monoethylenically unsaturated, hydrophilic monomer (monomer (b)). More particularly, the acrylamide polymer P is a copolymer comprising (meth)acrylamide and at least one anionic, monoethylenically unsaturated, hydrophilic monomer (monomer (b)) comprising at least one acidic group selected from the group of —COOH, —SO₃H and —PO₃H₂ or salts thereof. Especially preferably, the acrylamide polymer P is a copolymer comprising (or consisting essentially of) (meth)acrylamide and acrylic acid and/or AMPS (2-acrylamido-2-methylpropane-1-sulfonic acid, H₂C═CH—CO—NH—C(CH₃)₂—CH₂—SO₃H).

Typically, the acrylamide polymer P is a copolymer comprising, as well as (meth)acrylamide, at least one of the following monomers:
(a) at least one monoethylenically unsaturated, hydrophobically associating monomer (monomer (a));
(b) at least one monoethylenically unsaturated, hydrophilic monomer (monomer (b)); selected from
(b1) uncharged, monoethylenically unsaturated, hydrophilic monomers (b1), especially selected from the group of N-methyl(meth)acrylamide, N,N′-dimethyl(meth)acrylamide or N-methylol(meth)acrylamide;
(b2) anionic, monoethylenically unsaturated, hydrophilic monomers (b2) comprising at least one acidic group selected from —COOH, —SO₃H and —PO₃H₂ or salts thereof;
(b3) cationic, monoethylenically unsaturated, hydrophilic monomers (b3) comprising ammonium ions; for example ammonium derivatives of N-(ω-aminoalkyl)(meth)acrylamides or ω-aminoalkyl (meth)acrylates, e.g. 3-trimethylammoniopropylacrylamide chloride (DIMAPAQUAT), 2-trimethylamnnonioethyl methacrylate chloride (MADAME-QUAT) and quaternized dimethylaminoethyl acrylate (H₂C═CH—CO—O—CH₂CH₂N(CH₃)₃⁺ Cl), (DMA3Q);
(b4) monoethylenically unsaturated, hydrophilic monomers (b4) comprising hydroxyl and/or ether groups, for example hydroxyethyl (meth)acrylate, hydroxypropyl (meth)acrylate, allyl alcohol, hydroxyvinyl ethyl ether, hydroxyvinyl propyl ether or hydroxyvinyl butyl ether;
(c) at least one monoethylenically unsaturated, hydrophobic monomer (monomer (c)); especially selected from N-alkyl- and N,N′-dialkyl(meth)acrylamides, where the number of carbon atoms in the alkyl radicals together is at least 3, preferably at least 4, for example N-butyl(meth)acrylamide, N-cyclohexyl(meth)acrylamide or N-benzyl(meth)acrylamide;
(d) at least one monomer (d) which is a stabilizer S of the formula (I) which comprises at least one unsaturated bond (C—C double bond and/or C—C triple bond).

The monomers (a), (b1), (b2), (b3), (b4), (c) and (d) are described in detail hereinafter.

Preferably, the acrylamide polymer P comprises hydrophobically associating acrylamide copolymers as described in WO 2010/133527 and WO 2012/069478. It is also possible with preference to use acrylamide copolymers comprising cationic groups as described in U.S. Pat. No. 7,700,702.

### Monomer (a):

The acrylamide polymer P (or acrylamide copolymer) may preferably be a hydrophobically associating copolymer which, as well as (meth)acrylamide, comprises at least one monoethylenically unsaturated monomer (a) which imparts hydrophobically associating properties to the acrylamide copolymer and is therefore referred to hereinafter as hydrophobically associating monomer. The hydrophobically associating acrylamide copolymers are water-soluble copolymers having hydrophobic groups. In aqueous solution, the hydrophobic groups can associate with one another or with other hydrophobic groups and thicken the aqueous medium through this interaction.

The person skilled in the art is aware that the solubility of hydrophobically associating copolymers in water, according to the nature of the monomers used, may be more or less strongly pH-dependent. The reference point for the assessment of water solubility should therefore in each case be the pH desired for the respective end use of the copolymer. In the ideal case, the hydrophobically associating copolymers should be miscible with water in any ratio. Typically, however, it is sufficient when the copolymers are water-soluble at least at the desired use concentration and at the desired pH. In general, the solubility in water at room temperature should be at least 20 g/l, preferably at least 50 g/l and more preferably at least 100 g/l. The term “water-soluble” especially also encompasses alkali-soluble dispersions of polymers, i.e. polymers which are in the form of dispersions within the acidic pH range and only dissolve in water and display their thickening action in the alkaline pH range.

Suitable monomers (a) especially have the general formula H₂C═C(R^{P1})—Y^{P}—Z^{P} where R^{1P} is H or methyl, Z^{P} is a terminal hydrophobic group and Y^{P} is a linking hydrophilic group. In a preferred embodiment of the invention, the hydrophobic group Z^{P} comprises aliphatic and/or aromatic, straight-chain or branched C₈₋₃₂-hydrocarbyl radicals, preferably C₁₂₋₃₀-hydrocarbyl radicals. In a further preferred embodiment, the Z^{P} group may be a group of alkylene oxide units having at least 3 carbon atoms, preferably at least 4 and more preferably at least 5 carbon atoms. The Y^{P} group is preferably a group comprising alkylene oxide units, for example a group comprising 5 to 150 alkylene oxide units, bonded to the H₂C═C(R^{P1})-group in a suitable manner, for example, by means of a single bond or a suitable linking group, where at least 50 mol %, preferably at least 90 mol %, of ethylene oxide units are used.

Preferably, at least one of the monoethylenically unsaturated water-soluble monomers (a) is at least one selected from the group of

H₂C═C(R^{1P})—R^{2P}—O-(—CH₂—CH(R^{3P})—O—)ₖ-(—CH₂—CH(R^{4P})—O—)ₗ-R^{5P} (IP),

H₂C═C(R^{1P})—O-(—CH₂—CH(R^{3P})—O—)ₖ-R^{6P} (IIP),

H₂C═C(R^{1P})—(C═O)—O-(—CH₂—CH(R^{3P})—O—)ₖ-R^{6P} (IIIP).

### Monomer (a) of the Formula (IP):

Preferably, the monomer (a) is a monomer of the general formula (IP).

In the monomers (a) of the formula (IP), an ethylenic group H₂C═C(R^{1P})— is bonded by a bivalent linking —R^{2P}—O— group to a polyoxyalkylene radical having block structure -(—CH₂—CH(R^{3P})—O—)ₖ-(—CH₂—CH(R^{4P})—O—)ₗ-R^{5P}, where the two -(—CH₂—CH(R^{3P})—O—)ₖ and -(—CH₂—CH(R^{4P})—O—)ₗ blocks are arranged in the sequence shown in formula (I). The polyoxyalkylene radical has either a terminal OH group or a terminal ether group —OR^{5P}.

In the abovementioned formula, R^{1P} is H or a methyl group.

R^{2P} is a single bond or a bivalent linking group selected from the group consisting of —(CₙH₂ₙ)— [R^{2aP} group], —O—(C_{n′}H_{2n′})— [R^{2bP} group] and —C(O)—O—(C_{n″}H_{2n″})— [R^{2cP} group]. In each of said formulae, n is a natural number from 1 to 6, n′ and n″ are each a natural number from 2 to 6. In other words, the linking group comprises straight-chain or branched aliphatic hydrocarbyl groups having 1 to 6 or 2 to 6 carbon atoms, which are joined directly, via an ether group —O— or via an ester group —C(O)—O— to the ethylenic group H₂C═C(R^{1P})—. Preferably, the —(CₙH₂ₙ)—, —(C_{n′}H_{2n′})— and —(C_{n″}H_{2n″})— groups are linear aliphatic hydrocarbyl groups.

Preferably, the R^{2aP} group is a group selected from —CH₂—, —CH₂—CH₂— and —CH₂—CH₂—CH₂—, more preferably a methylene group —CH₂—.

Preferably, the R^{2bP} group is a group selected from —O—CH₂—CH₂—, —O—CH₂—CH₂—CH₂— and —O—CH₂—CH₂—CH₂—CH₂—, more preferably —O—CH₂—CH₂—CH₂—CH₂—.

Preferably, the R^{2cP} group is a group selected from —C(O)—O—CH₂—CH₂—, —C(O)O—CH(CH₃)—CH₂—, —C(O)O—CH₂—CH(CH₃)—, —C(O)O—CH₂—CH₂—CH₂—CH₂— and —C(O)O—CH₂—CH₂—CH₂—CH₂—CH₂—CH₂—, more preferably-C(O)—O—CH₂—CH₂— and —C(O)O—CH₂—CH₂—CH₂—CH₂— and most preferably —C(O)—O—CH₂—CH₂—.

More preferably, the R^{2P} group is an R^{2aP} or R^{2bP} group, more preferably an R^{2bP} group.

In addition, R^{2P} is more preferably a group selected from —CH₂— or —O—CH₂—CH₂—CH₂—CH₂—, most preferably —O—CH₂—CH₂—CH₂—CH₂—.

The monomers (I) additionally have a polyoxyalkylene radical consisting of the -(—CH₂—CH(R^{3P})—O—)ₖ and -(—CH₂—CH(R^{4P}—O—)ₗ units, where the units are arranged in block structure in the sequence shown in formula (I). The transition between the two blocks may be abrupt or else continuous.

In the -(—CH₂—CH(R^{3P}—O—)ₖ block, the R^{3P} radicals are each independently H, methyl or ethyl, preferably H or methyl, with the proviso that at least 50 mol % of the R^{3P} radicals are H. Preferably at least 75 mol % of the R^{3P} radicals are H, more preferably at least 90 mol %, and they are most preferably exclusively H. Said block is thus a polyoxyethylene block which may optionally also have certain proportions of propylene oxide and/or butylene oxide units, preferably a pure polyoxyethylene block.

The number of alkylene oxide units k is a number from 10 to 150, preferably 12 to 100, more preferably 15 to 80, even more preferably 20 to 30 and, for example, about 22 to 25. It will be clear to the person skilled in the art in the field of polyalkylene oxides that the numbers mentioned are mean values of distributions.

In the second, terminal -(—CH₂—CH(R^{4P})—O—)ₗ- block, the R^{4P} radicals are each independently hydrocarbyl radicals of at least 2 carbon atoms, preferably at least 3 and more preferably 3 to 10 carbon atoms. This may be an aliphatic and/or aromatic, linear or branched hydrocarbyl radical. Preference is given to aliphatic radicals.

Examples of suitable R^{4P} radicals include ethyl, n-propyl, n-butyl, n-pentyl, n-hexyl, n-heptyl, n-octyl, n-nonyl or n-decyl and phenyl. Examples of preferred radicals include n-propyl, n-butyl and n-pentyl, and particular preference is given to an n-propyl radical.

The R^{4P} radicals may additionally be ether groups of the general formula —CH₂—O—R^{4P′} where R^{4P} is an aliphatic and/or aromatic, linear or branched hydrocarbyl radical having at least 2 carbon atoms, preferably at least 3 and more preferably 3 to 10 carbon atoms. Examples of R^{4P′} radicals include n-propyl, n-butyl, n-pentyl, n-hexyl, 2-ethylhexyl, n-heptyl, n-octyl, n-nonyl, n-decyl or phenyl.

The -(—CH₂—CH(R^{4P})—O—)ₗ- block is thus a block consisting of alkylene oxide units having at least 4 carbon atoms, preferably at least 5 carbon atoms and/or glycidyl ethers having an ether group of at least 2, preferably at least 3 carbon atoms. Preferred R^{4P} radicals are the hydrocarbyl radicals mentioned; the units for the second terminal block are more preferably alkylene oxide units comprising at least 5 carbon atoms, such as pentene oxide units or units of higher alkylene oxides.

The number of alkylene oxide units l is a number from 5 to 25, preferably 6 to 20, more preferably 8 to 18, even more preferably 10 to 15 and, for example, about 12.

The R^{5P} radical is H or a preferably aliphatic hydrocarbyl radical having 1 to 30 carbon atoms, preferably 1 to 10 and more preferably 1 to 5 carbon atoms. Preferably, R^{5P} is H. methyl or ethyl, more preferably H or methyl and most preferably H.

In the monomers of the formula (I) a terminal, monoethylenic group is thus joined to a polyoxyalkylene group having block structure, first of all by a hydrophilic block having polyethylene oxide units and the latter in turn by a second terminal, hydrophobic block formed at least from butene oxide units, preferably at least pentene oxide units or units of higher alkylene oxides, for example dodecene oxide. The second block has a terminal —OR^{5P} group, especially an OH group. The end group need not be etherified with a hydrocarbyl radical for hydrophobic association; instead, the terminal -(—CH₂—CH(R^{4P})—O—)ₗ block itself with the R^{4P} radicals is responsible for the hydrophobic association of the copolymers prepared using the monomers (a). Etherification is just one option that may be selected by the person skilled in the art according to the desired properties of the copolymer.

It will be clear to the person skilled in the art in the field of polyalkylene oxide block copolymers that the transition between the two blocks may be abrupt or else continuous according to the method of preparation. In the case of a continuous transition, there is also a transition zone comprising monomers of both blocks between the two blocks. If the block boundary is fixed at the middle of the transition zone, it is accordingly possible for the first -(—CH₂—CH(R^{3P})—O—)ₖ block still to have small amounts of —CH₂—CH(R^{4P})—O— units and for the second -(—CH₂—CH(R^{4P})—O—)ₗ- block to have small amounts of —CH₂—CH(R^{P3})—O— units, although these units are not distributed randomly through the block but are arranged within the transition zone mentioned.

The invention preferably relates to a composition as described above, wherein the at least one acrylamide polymer P is a copolymer comprising (meth)acrylamide and at least one monoethylenically unsaturated, hydrophobically associating monomer (a), where the monomer (a) has the following structure (IP):

H₂C═C(R^{1P})—R^{2P}—O-(—CH₂—CH(R^{3P})—O—)ₖ-(—CH₂—CH(R^{4P})—O—)ₗ-R^{5P} (IP)
where
RIP is H or a methyl group;
R^{2P} is a single bond or a divalent linking group selected from the group consisting of —(CₙH₂ₙ)—, —O—(C_{n′}H_{2n′})— and C(O)—O—(C_{n″}H_{2n″})—, where n is a natural number from 1 to 6 and n′ and n″ are each a natural number from 2 to 6;
R^{3P} is independently H, methyl or ethyl;
R^{4P} is independently a hydrocarbyl radical of at least 2 carbon atoms;
R^{5P} is H or a hydrocarbyl radical having 1 to 30 carbon atoms;
k is a number from 10 to 150;
l is a number from 5 to 25.

For the radicals and indices, the abovementioned preferred embodiments apply.

The hydrophobically associating monomers (a) of the formula (I), acrylamide copolymers comprising these monomers (a) and the preparation thereof are known in principle to those skilled in the art, for example from WO2010/133527 and WO2012/069478.

### Monomers (a) of the Formulae (IIP) and (IIIP):

In the monomers of the formulae (IIP) and (IIIP), R^{1P}, R^{3P} and k are defined as outlined above.

R^{6P} is an aliphatic and/or aromatic, straight-chain or branched hydrocarbyl radical having 8 to 40 carbon atoms, preferably 12 to 32 carbon atoms. For example, it may be n-alkyl groups such as n-octyl, n-decyl or n-dodecyl groups, phenyl groups and especially substituted phenyl groups. Substituents on the phenyl groups may be alkyl groups, for example C1- to C6-alkyl groups, preferably styryl groups. Particular preference is given to a tristyrylphenyl group.

The hydrophobically associating monomers of the formulae (IIP) and (IIIP) and the preparation thereof are known in principle to those skilled in the art, for example from EP 705 854 A1.

### Amounts of the Monomers (a):

The amount of the monoethylenically unsaturated, hydrophobically associating monomers (a) is preferably 0.1 to 15% by weight based on the total amount of all the monomers in the acrylamide copolymer, especially preferably 0.1 to 10% by weight, more preferably 0.2 to 5% by weight and often 0.5 to 2% by weight.

In general, at least 50% by weight, preferably at least 80% by weight, of the monomers (a) are monomers (a) of the general formula (IP), (IIP) and/or (IIIP), and preferably only monomers (a) of the general formula (IP), (IIP) and/or (IIIP) are used. More preferably, only monomers (a) of the general formula (IP) are used in the preparation of the inventive acrylamide copolymers, most preferably monomers (a) of the general formula (I) in which R^{2P} is an R^{2bP} radical.

Further preferably, the acrylamide polymer P may be a copolymer as described in WO 2010/133527. Preferably, the at least one acrylamide polymer P is a water-soluble, hydrophobically associating copolymer comprising:
(a) 0.1 to 20% by weight of at least one monoethylenically unsaturated, hydrophobically associating monomer (a) as described above, and
(b) 25% by weight to 99.9% by weight of at least one different monoethylenically unsaturated, hydrophilic monomer (b), with the proviso that at least 10% by weight, preferably at least 15% by weight and especially preferably more than 45% by weight, more preferably more than 60% by weight, of (meth)acrylamide, based on the total amount of all the monomers in the acrylamide polymer P, is present;
   where the stated amounts, unless stated otherwise, are each based on the total amount of all the monomers in the copolymer, and where at least one of the monomers (a) is a monomer of the general formula (IP)

H₂C═C(R^{1P})—R^{2P}—O-(—CH₂—CH(R^{3P})—O—)ₖ-(—CH₂—CH(R^{4P})—O—)ₗ-R⁵ (IP)

where the -(—CH₂—CH(R^{3P}—O—)ₖ and -(—CH₂—CH(R^{4P})—O—)ₗ units are arranged in block structure in the sequence shown in formula (IP) and the radicals and indices are each defined as follows:
k: a number from 10 to 150,
l: a number from 5 to 25,
R^{1P}: H or methyl,
R^{2P}: single bond or a bivalent linking group selected from the group of —(CₙH₂ₙ)— [R^{4aP}], —O—(C_{n′}H_{2n′})— [R^{4bP}] and —C(O)—O—(C_{n″}H_{2n″})— [R^{4cP}], where n, n′ and n″ are each a natural number from 1 to 6,
R^{3P}: independently H, methyl or ethyl, with the proviso that at least 50 mol % of the R² radicals are H,
R^{4P}: independently a hydrocarbyl radical having at least 2 carbon atoms or an ether group of the general formula —CH₂—O—R^{4P′} where R^{4P′} is a hydrocarbyl radical having at least 2 carbon atoms,
R^{5P}: H or a hydrocarbyl radical having 1 to 30 carbon atoms.

Further preferably, the acrylamide polymer P may be a copolymer as described in WO 2012/069478. Preferably, the at least one acrylamide polymer P is a water-soluble, hydrophobically associating copolymer comprising, as well as acrylamide:
(a) 0.1 to 15% by weight of at least one monoethylenically unsaturated, hydrophobically associating monomer (a), and
(b) 85 to 99.9% by weight of at least two different monoethylenically unsaturated, hydrophilic monomers (b), where the monomers (b) are at least
   (b1) at least one uncharged, monoethylenically unsaturated, hydrophilic monomer (b1) selected from the group of (meth)acrylamide, N-methyl(meth)acrylamide, N,N′-dimethyl(meth)acrylamide and N-methylol(meth)acrylamide, with the proviso that at least 10% by weight, preferably at least 15% by weight and especially preferably more than 45% by weight, more preferably more than 60% by weight, of (meth)acrylamide, based on the total amount of all the monomers in the acrylamide polymer P, is present;
   (b2) at least one anionic, monoethylenically unsaturated, hydrophilic monomer (b2) which trades at least one acidic group selected from the group of —COOH, —SO₃H and —PO₃H₂ or salts thereof,
      where the FIGURES stated, unless stated otherwise, are each based on the total amount of all the monomers in the copolymer.

### Monomers (b):

The acrylamide copolymer can preferably comprise at least one monoethylenically unsaturated, hydrophilic monomer (b), with the proviso that at least 10% by weight, preferably at least 15% by weight and especially preferably more than 45% by weight, more preferably more than 60% by weight, of (meth)acrylamide, based on the total amount of all the monomers in the acrylamide polymer P, is present.

Preferably, the hydrophilic monomers (b) have functional groups selected from the group consisting of carbonyl groups >C═O, ether groups —O—, especially polyethylene oxide groups —(CH₂—CH₂—O—)ₙ- where n is preferably a number from 1 to 200, hydroxyl groups —OH, primary, secondary or tertiary amino groups, ammonium groups, amide groups —C(O)—NH—, carboxamide groups —C(O)—NH₂ or acidic groups such as carboxyl groups —COOH, sulfo groups —SO₃H, phosphonic acid groups —PO₃H₂ or phosphoric acid groups —OP(OH)₃. Examples of preferred functional groups comprise hydroxyl groups —OH, carboxyl groups —COOH, sulfo groups —SO₃H, carboxamide groups —C(O)—NH₂, amide groups —C(O)—NH— and polyethylene oxide groups —(CH₂—CH₂—O—)ₙ-H where n is preferably a number from 1 to 200.

The functional groups may be attached directly to the ethylenic group, or else are bonded via one or more linking hydrocarbyl groups to the ethylenic group.

More preferably, the monoethylenically unsaturated hydrophilic monomers (b) used are miscible with water in any ratio, but it is sufficient for execution of the invention that the acrylamide copolymer has the water solubility mentioned at the outset. In general, the solubility of the monomers (b) in water at room temperature should be at least 50 g/l, preferably at least 150 g/l and more preferably at least 250 g/l.

The amount of all the hydrophilic monomers (b) in the acrylamide copolymer is typically 85 to 99.9% by weight, based on the total amount of all the monomers in the copolymer, preferably 90 to 99.8% by weight, with the proviso that at least 10% by weight, preferably at least 15% by weight and especially preferably more than 45% by weight, more preferably more than 60% by weight, of (meth)acrylamide, based on the total amount of all the monomers in the acrylamide polymer P, is present.

The amount of the uncharged, hydrophilic monomers (b1) here is generally 10 to 95% by weight, preferably 30 to 95% by weight, preferably 30 to 85% by weight and more preferably 30 to 70% by weight, based on the total amount of all the monomers used, with the proviso that at least 10% by weight, preferably at least 15% by weight and especially preferably more than 45% by weight, more preferably more than 60% by weight, of (meth)acrylamide, based on the total amount of all the monomers in the acrylamide polymer P, is present.

If the acrylamide copolymer P comprises only uncharged monomers (b1) and anionic monomers (b2), it has been found to be useful to use the uncharged monomers (b1) including (meth)acrylamide in an amount of 30 to 95% by weight and the anionic monomers (b2) in an amount of 4.9 to 69.9% by weight, the amount being based in each case on the total amount of all the monomers used. In this embodiment, the monomers (b1) are preferably used in an amount of 30 to 80% by weight and the anionic monomers (b2) in an amount of 19.9 to 69.9% by weight, and the monomers (b1) are more preferably used in an amount of 40 to 70% by weight and the anionic monomers (b2) in an amount of 29.9 to 59.9% by weight.

If the copolymer comprises uncharged monomers (31), anionic monomers (b2) and cationic monomers (b3), it has been found to be useful to use the uncharged monomers (b1) including (meth)acrylamide in an amount of 30 to 95% by weight and the anionic (b2) and cationic monomers (b3) together in an amount of 4.9 to 69.9% by weight, with the proviso that the molar ratio (b2)/(b3) is 0.7 to 1.3. Preferably, the molar ratio (b2)/(b3) is 0.8 to 1.2 and, for example, 0.9 to 1.1. This measure makes it possible to obtain copolymers which are particularly insensitive to salt burden. In this embodiment, the monomers (131) are preferably used in an amount of 30 to 80% by weight and the anionic and cationic monomers (b2)+(b3) together in an amount of 19.9 to 69.9% by weight, and the monomers (b1) are more preferably used in an amount of 40 to 70% by weight and the anionic and cationic monomers (b2)+(b3) together in an amount of 29.9 to 59.9% by weight, and the molar ratio already mentioned should be complied with in each case.

### Monomers (b1):

The acrylamide copolymer may typically comprise, as well as (meth)acrylamide, at least one other uncharged, monoethylenically unsaturated, hydrophilic monomer (b1) selected from the group of N-methyl(meth)acrylamide, N,N′-dimethyl(meth)acrylamide and N-methylol(meth)-acrylamide, with the proviso that at least 10% by weight, preferably at least 15% by weight and especially preferably more than 45% by weight, more preferably more than 60% by weight, of (meth)acrylamide, based on the total amount of all the monomers in the acrylamide polymer P, is present.

It is additionally possible to use, as monomer (b1), exclusively (meth)acrylamide, especially acrylamide.

### Monomers (b2):

In a preferred embodiment, the acrylamide copolymer used comprises, as well as (meth)acrylamide, additionally at least one hydrophilic, monoethylenically unsaturated anionic monomer (b2) comprising at least one acidic group selected from the group of —COOH, —SO₃H and —PO₃H₂ or salts thereof. Preference is given to monomers comprising COOH groups and/or —SO₃H groups, particular preference to monomers comprising —SO₃H groups. It will be appreciated that the salts of the acidic monomers may also be involved. Suitable counterions comprise especially alkali metal ions such as Li⁺, Na⁺ or K⁺, and also ammonium ions such as NH₄⁺ or ammonium ions having organic radicals.

Examples of monomers comprising COOH groups include acrylic acid, methacrylic acid, crotonic acid, itaconic acid, maleic acid or fumaric acid. Preference is given to acrylic acid.

Examples of monomers (b2) comprising sulfa groups include vinylsulfonic acid, allylsulfonic acid, 2-acrylamido-2-methylpropanesulfonic acid, 2-methacrylamido-2-methylpropanesulfonic acid, 2-acrylamidobutanesulfonic acid, 3-acrylamido-3-methyl-butanesulfonic acid or 2-acrylamido-2,4,4-trimethylpentanesulfonic acid. Preference is given to vinylsulfonic acid, allylsulfonic acid or 2-acrylamido-2-methylpropanesulfonic acid and particular preference to 2-acrylamido-2-methylpropanesulfonic acid (APMS) or salts thereof.

Examples of monomers (b2) comprising phosphonic acid groups include vinylphosphonic acid, allylphosphonic acid, N-(meth)acrylamidoalkylphosphonic acids or (meth)acryloyloxyalkyl-phosphonic acids, preferably vinylphosphonic acid.

Preferably, monomer (b2) may be selected from the group consisting of acrylic acid, methacrylic acid, crotonic acid, itaconic acid, maleic acid, fumaric acid, vinylsulfonic acid, allylsulfonic acid, 2-acrylamido-2-methylpropanesulfonic acid (AMPS), 2-methacrylamido-2-methylpropane-sulfonic acid, 2-acrylamidobutanesulfonic acid, 3-acrylamido-3-methylbutanesulfonic acid, 2-acrylamido-2,4,4-trimethylpentanesulfonic acid, vinylphosphonic acid, allylphosphonic acid, N-(meth)acrylamidoalkylphosphonic acids and (meth)acryloyloxyalkylphosphonic acids, more preferably from acrylic acid and/or APMS or salts thereof.

Further preferably, the acrylamide polymer P is a copolymer comprising (meth)acrylamide and at least two further monomers (b2) comprising different acidic groups. It is especially preferably a copolymer comprising (meth)acrylamide and, as monomers (b2) comprising acidic groups, a monomer comprising the —SO₃H group (e.g. 2-acrylamido-2-methylpropanesulfonic acid (AMPS)) and a monomer comprising the —COOH group (e.g. acrylic acid). Especially preferably, the acrylamide polymer P is a copolymer comprising (meth)acrylamide, 2-acrylamido-2-methylpropanesulfonic acid (AMPS) and acrylic acid.

For the sake of completeness, it should be mentioned that the monomers (b1) can under some circumstances be hydrolyzed at least partly to (meth)acrylic acid in the course of preparation and use. The copolymers used in accordance with the invention may accordingly comprise (meth)acrylic acid units even if no (meth)acrylic acid units at all have been used for the synthesis. The tendency of the monomers (b1) to be hydrolyzed increases with increasing content of sulfo groups. Accordingly, the presence of sulfo groups in the acrylamide copolymer used is advisable.

### Monomers (b3):

The acrylamide polymer P may optionally comprise, as well as (meth)acrylamide, at least one monoethylenically unsaturated, cationic monomer (b3) having ammonium ions.

Suitable cationic monomers (b3) comprise especially monomers having ammonium groups, especially ammonium derivatives of N-(ω-aminoalkyl)(meth)acrylamides or ω-aminoalkyl (meth)acrylates.

More particularly, monomers (b3) having ammonium groups may be compounds of the general formulae H₂C═C(R^{8P})—CO—NR^{9P}—R^{10P}—N(R^{11P})₃⁺ M⁻ (Va) and/or H₂C═C(R^{8P})—COO—R^{10P}—N(R^{11P})₃⁺ X⁻ (Vb). In these formulae, R^{8P} is H or methyl, R^{9P} is H or a to aralkyl group, preferably H or methyl and R^{10P} is a preferably linear C₁- to C₄-alkylene group, for example a 1,2-ethylene group —CH₂—CH₂— or a 1,3-propylene group —CH₂—CH₂—CH₂—.

The R^{11P} radicals are each independently C₁- to C₄-alkyl radicals, preferably methyl or a group of the general formula —R^{12P}—SO₃H where R^{12P} is a preferably linear C₁- to C₄-alkylene group or a phenyl group, with the proviso that generally not more than one of the R^{11P} substituents is a substituent having sulfo groups. More preferably, the three R^{11P} substituents are methyl groups, meaning that the monomer has an —N(CH₃)₃⁺ group. M⁻ in the above formula is a monovalent anion, for example Cl⁻. It will be appreciated that M⁻ may also be a corresponding fraction of a polyvalent anion, although this is not preferred. Examples of preferred monomers (b3) of the general formula (Va) or (Vb) comprise salts of 3-trimethylammoniopropyl(meth)acrylamides or 2-trimethylammonioethyl (meth)acrylates, for example the corresponding chlorides such as 3-trimethylammonlopropylacrylamide chloride (DIMAPAQUAT) and 2-trimethylammonioethyl methacrylate chloride (MADAME-QUAT).

In a preferred embodiment, the acrylamide polymer P comprises at least one (meth)acrylamide and at least one cationically modified polyacrylamide, especially DMA3Q, quaternized dimethylaminoethyl acrylate, (H₂C═CH—CO—O—CH₂CH₂N(CH₃)₃⁺ Cl), generally —N(CH₃)₂—R (R=long-chain alkyl).

In one embodiment of the invention, the acrylamide copolymer may be an acrylamide copolymer described in US 2007/0287815. More particularly, the at least one acrylamide polymer P is a copolymer comprising (meth)acrylamide and at least one cationic monomer of the structure (KI):

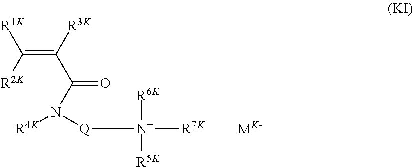

where the radicals and indices are each defined as follows;
R^{1K}, R^{2K}, R^{3K}, R^{5K}, R^{6K}
   are each independently H or C₁₋₄ alkyl;
Q: is C₁₋₈-alkylene;
R^{7K}: is a C₈₋₃₀ alkyl or C₈₋₃₀-arylalkyl;
M^{K}: is a halogen selected from bromine, chlorine, iodine and fluorine or a negatively charged counterion.

More particularly, the acrylamide copolymer may comprise, as the cationic acrylic-based monomer (monomer b3), at least one monomer selected from N-acrylamidopropyl-N,N-dimethyl-N-dodecylammonium chloride (DMAPA C1(C12)), N-methacrylamidopropyl-N,N-dimethyl-N-dodecylammonium chloride (DMAPMA C1(C12)), N-acrylamidopropyl-N,N-dimethyl-N-dodecylammonium bromide (DMAPA Br(C12)), N-methacrylamidopropyl-N,N-dimethyl-N-dodecylammonium bromide (DMAPMA Br(C12)), N-acrylamidopropyl-N,N-dimethyl-N-octadecylammonium chloride (DMAPA C1(C18)), N-methacrylamidopropyl-N,N-dimethyl-N-octadecylammonium chloride (DMAPMA C1(C18)), N-acrylamidopropyl-N,N-dimethyl-N-octadecylammonium bromide (DMAPA Br(C18)), N-methacrylamidopropyl-N,N-dimethyl-N-octadecylammonium bromide (DMAPMA Br(C18)).

In a further embodiment of the invention, it is possible to use the copolymers described in US 2007/0287815. More particularly, the acrylamide polymer P used may be a copolymer having a molecular weight greater than 50 000 g/mol comprising:
0.005 to 10% by weight
of at least one above-described cationic monomer of the formula (KI);
5 to 89% by weight
of at least one anionic monomer having an acryloyl, vinyl, maleic acid, fumaric acid or allyl functionality and comprising a carboxyl group, phosphonate group or sulfonate group, where the anionic monomer may be an above-described monomer (b2), the anionic monomer preferably being selected from acrylic acid, methacrylic acid, 2-acrylamido-2-methylpropanesulfonic acid and salts thereof; and
10 to 90% by weight
of at least one nonionic monomer, where the nonionic monomer may be an above-described monomer (b1), the nonionic monomer preferably being selected from acrylamide, methacrylamide, N-isopropylacrylamide, N,N-dimethylacrylamide, N-vinylformamide, N-vinylacetamide and N-vinylpyrrolidone,
with the proviso that at least 10% by weight, preferably at least 15% by weight and especially preferably more than 45% by weight, more preferably more than 60% by weight, of (meth)acrylamide, based on the total amount of all the monomers in the acrylamide polymer P, is present.

The acrylamide polymer P used may also be the copolymer just described having a molecular weight greater than 50 000 g/mol, where the stated amounts refer to mol %. A process for preparing such acrylamide copolymers comprising cationic monomers is described in US 2007/0287815.

The anionic monomer may especially be acrylic acid, methacrylic acid, itaconic acid, crotonic acid, maleic acid, fumaric acid, 2-acrylamido-2-methylpropanesulfonic acid, vinylsulfonic acid, vinylphosphonic acid, allylsulfonic acid, allylphosphonic acid, styrenesulfonic acid and the water-soluble salts thereof with alkali metal, alkaline earth metal and ammonium.

The nonionic monomer may especially be (meth)acrylamide, isopropylacrylamide, N,N-dimethylacrylamide, N-methylolacrylamide, N-vinylformamide, N-vinylacetamide, N-vinylpyridine and/or N-vinylpyrrolidone, with the proviso that at least 10% by weight, preferably at least 15% by weight and especially preferably more than 45% by weight, more preferably more than 60% by weight, of (meth)acrylamide, based on the total amount of all the monomers in the acrylamide polymer P, is present.

### Monomers (b4)

The acrylamide copolymers used in accordance with the invention may additionally comprise further monoethylenically unsaturated, hydrophilic monomers (b4) other than the hydrophilic monomers (b1), (b2) and (b3). Examples of such monomers include monomers comprising hydroxyl and/or ether groups, for example hydroxyethyl (meth)acrylate, hydroxypropyl (meth)acrylate, allyl alcohol, hydroxyvinyl ethyl ether, hydroxyvinyl propyl ether, hydroxyvinyl butyl ether or compounds of the formula H₂C═C(R^{1P})—COO-(—CH₂—CH(R^{13P})—O—)_{b}-R^{14P} (VIa) or H₂C═C(R^{1P})—O-(—CH₂—CH(R^{13P})—O—)_{b}-R^{14P} (VIb) where R^{1P} is as defined above and b is a number from 2 to 200, preferably 2 to 100. The R^{13P} radicals are each independently H, methyl or ethyl, preferably H or methyl, with the proviso that at least 50 mol % of the R^{13P} radicals are H. Preferably at least 75 mol % of the R^{13P} radicals are H, more preferably at least 90 mol %, and they are most preferably exclusively H. The R^{14P} radical is H, methyl or ethyl, preferably H or methyl. Further examples of monomers (b4) include N-vinyl derivatives, for example N-vinylformamide, N-vinylacetamide, N-vinylpyrrolidone or N-vinylcaprolactam, and also vinyl esters, for example vinyl formate or vinyl acetate. N-Vinyl derivatives can be hydrolyzed after polymerization to vinylamine units, and vinyl esters to vinyl alcohol units.

### Monomers (c)

As well as the above-described monomers, the acrylamide polymer P may comprise further monoethylenically unsaturated monomers (c). It will be appreciated that it is also possible to use mixtures of a plurality of different monomers (c).

Such monomers can be used for fine control of the properties of the acrylamide copolymer. If they are present at all, the amount of such optional monomers (c) may be up to 14.9% by weight, preferably up to 9.9% by weight, more preferably up to 4.9% by weight, based in each case on the total amount of all the monomers. Most preferably, no monomers (c) are present.

The monomers (c) may, for example, be monoethylenically unsaturated monomers which have a more hydrophobic character than the hydrophilic monomers (b) and which are accordingly only slightly water-soluble. In general, the solubility of the monomers (c) in water at room temperature is less than 50 g/l, especially less than 30 g/l. Examples of such monomers include N-alkyl- and N,N′-dialkyl(meth)acrylamides, where the number of carbon atoms in the alkyl radicals together is at least 3, preferably at least 4. Examples of such monomers include N-butyl(meth)acrylamide, N-cyclohexyl(meth)acrylamide or N-benzyl(meth)acrylamide.

### Monomers (d)

As well as the above-described monomers, the acrylamide polymer P may optionally comprise at least one monomer (d) which is a stabilizer S of the formula (I) comprising at least one unsaturated bond (C—C double bond and/or C—C triple bond). Preferably, the monomer (d) comprises exactly one C—C double bond or C—C triple bond. Preferably, the monomer (d) comprises exactly one terminal C—C double bond or C—C triple bond. Preferably, the monomer comprises exactly one terminal C—C double bond. For example, it is possible to use one or more of the following monomers (d):

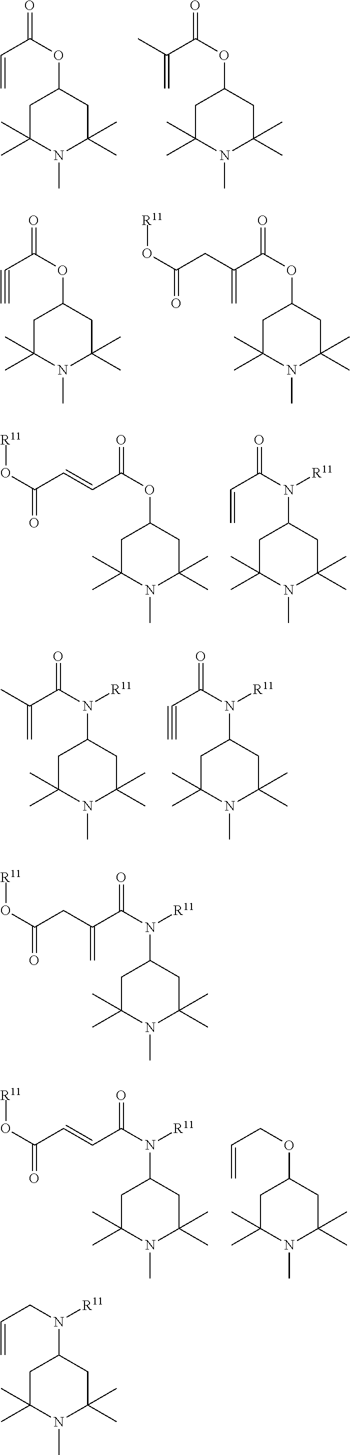

with R¹¹=H; C₁₋₈-alkyl or 1,2,2,6,6-pentamethylpiperidin-4-yl.

If present, the amount of the optional monomers (d) may be up to 14.9% by weight, preferably up to 9.9% by weight, more preferably up to 4.9% by weight, based in each case on the total amount of all the monomers. Preferably, the amount of the monomers (d) may be from 0.01 to 14.9% by weight, preferably 0.1 to 4.9% by weight. It is also possible to use mixtures of a plurality of different monomers (d).

In a preferred embodiment, the acrylamide polymer P has a weight-average molecular weight Mw of at least 1*10⁶ g/mol, preferably of 1*10⁶ g/mol to 30*10⁶ g/mol, typically about 20*10⁶ g/mol.

Preferably, the acrylamide polymer P has an anionicity in the range from 10 to 60%, preferably from 20 to 40%, more preferably from 20 to 30%. Anionicity is understood to mean the molar proportion of the monomers comprising acidic groups based on the total amount of acrylamide polymer P.

The acrylamide polymers P or acrylamide copolymers used in accordance with the invention can be prepared by methods known in principle to the person skilled in the art, for example by solution or gel polymerization in the aqueous phase. Polymerization is effected using (meth)acrylamide and optionally one or more of the monomers (a), (b) and (c) described above, initiator and optionally further auxiliaries in an aqueous medium. The process for preparation of the acrylamide polymers P and acrylamide copolymers is described, for example, in WO 2012/069478 and WO 2010/133527.

### Stabilizer S

According to the invention, the composition comprises at least one stabilizer S of the formula (I)

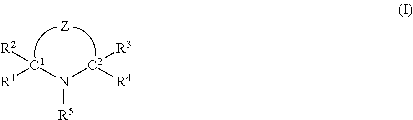

where the R¹, R², R³, R⁴ and R⁵ radicals and the bivalent Z group are each as defined above. C¹ and C² denote carbon atoms.

Preferably, Z is a bivalent group comprising 2 to 5, preferably 2 to 4, groups selected from C(R⁶)₂, N—R′ and C═O, where the Z group together with the carbon atoms C¹, C² and the nitrogen atom N forms a 5- to 8-membered (preferably 5- to 7-membered) ring, where R′ is selected from H, C₁₋₂₀-alkyl and C₁₋₂₀-hydroxyalkyl; preferably, R′=H. More preferably Z is a bivalent group comprising 3 atoms and/or groups selected from C(R⁶)₂, N—R′ and C═O, forming a 6-membered ring which, in a preferred embodiment, is substituted by exactly one R⁶ group (where R⁶ is not H) in position 4 (relative to the nitrogen atom); more preferably, R⁶=OH. In a further embodiment, the ring may be an unsubstituted 5- to 7-membered ring.

In a further embodiment, Z comprises 2 to 4, preferably 3, C(R⁶)₂ groups, where the Z group together with the carbon atoms C¹, C² and the nitrogen atom N forms a 5- to 7-membered, preferably 6-membered, ring. This ring is preferably substituted by exactly one R⁶ group in the 4 position (relative to the nitrogen atom). Further preferably, the ring is unsubstituted, meaning that Z preferably comprises 3 CH₂ groups.

Preferably, R¹, R², R³ and R⁴ are each independently selected from C₁₋₂₀-alkyl, C₂₋₂₀-alkenyl and C₇₋₃₂-arylalkyl; especially preferably from C₁₋₂₀-alkyl; more preferably from C₁₋₁₂-alkyl, even more preferably C₁₋₆-alkyl and especially preferably from methyl, ethyl, n-propyl and isopropyl. Especially preferably, R¹=R² and R³=R⁴; especially preferably, R¹=R²=R³=R⁴. More preferably, R¹=R²=R³=R⁴=methyl, ethyl, n-propyl or isopropyl; especially preferably, R¹=R²=R³=R⁴=methyl.

Preferably, R⁵ is selected from H; C₁₋₂₀-alkyl; C₂₋₂₀-alkenyl; C₇₋₃₂-arylalkyl; C₁₋₂₀-hydroxyalkyl; C₂₋₂₀-cyanoalkyl; C₁₋₂₀-sulfoalkyl; C₁₋₂₀-phosphonoalkyl; —(CH₂—CH(R^{a})—O)_{q}—H with q=1-20 and R^{a}=H or C₁₋₆-alkyl; —(O—CH₂—CH(R^{e})—(CH₂)ᵢ)ₚ—O—R^{e′} with p=1-20, i=0 or 1, R^{e}=H, OH or C₁₋₆-alkyl and R^{e′}=H or C₁₋₈-alkyl; —C(═O)—R^{e} with R^{e}=H, C₁₋₁₆-alkyl, C₂₋₁₈-alkenyl, C₆₋₂₀-aryl or C₇₋₂₀-arylalkyl; 2,2,6,6-tetramethyl-4-piperidinol-1-ylalkyl and 4-(2,2,6,6-tetramethyl-4-piperidinol-1-ylalkyl)-benzyl. Especially preferably, R⁵ is selected from H; C₁₋₂₀-alkyl; C₂₋₂₀-alkenyl; C₇₋₃₂-arylalkyl; C₁₋₂₀-hydroxyalkyl; C₁₋₂₀-cyanoalkyl; C₁₋₂₀-sulfoalkyl; C₁₋₂₀-phosphonoalkyl; 2,2,6,6-tetramethyl-4-piperidinol-1-ylalkyl and 4-(2,2,6,6-tetramethyl-4-piperidinol-1-ylalkyl)benzyl. More particularly, R⁵ is selected from C₁₋₁₂-alkyl (for example methyl, ethyl, n-propyl or isopropyl); C₂₋₁₂-alkenyl (for example allyl); C₇₋₂₀-arylalkyl (for example benzyl); C₁₋₁₂-cyanoalkyl (for example cyanomethyl); C₁₋₁₂-sulfoalkyl (for example 3-sulfopropyl); C₁₋₁₂-phosphonoalkyl (for example phosphonato-methyl); —(CH₂—CH(R^{a})—O)_{q}—H with q=1-10, preferably 1-5, especially preferably 1 and R^{a}=H or C₁₋₆-alkyl; —C(═O)—R^{e} with R^{e}=C₁₋₁₂-alkyl; 2,2,6,6-tetramethyl-4-piperidinol-1-ylalkyl and 4-(2,2,6,6-tetramethyl-4-piperidinol-1-ylalkyl)benzyl.

More particularly, 4-(2,2,6,6-tetramethyl-4-piperidinol-1-ylalkyl)benzyl is selected from 4-(2,2,6,6-tetramethyl-4-piperidinol-1-ylmethyl)benzyl) and 4-(2,2,6,6-tetramethyl-4-piperidinol-1-ylethyl)benzyl), preferably 4-(2,2,6,6-tetramethyl-4-piperidinol-1-ylmethyl)benzyl).

In a preferred embodiment, R⁵ is selected from H, C₁₋₂₀-alkyl, C₂₋₂₀-alkenyl, C₁₋₂₀-hydroxyalkyl or —(CH₂—CH(R^{a})—O)_{q}—H with q=1-20 and R^{a}=H or C₁₋₆-alkyl, preferably q=1 and R^{a}=H or C₁₋₄-alkyl. It is often preferable that R⁵ is selected from C₁₋₁₂-alkyl; C₂₋₁₂-alkenyl, C₁₋₁₂-hydroxyalkyl and —(CH₂—CH(R^{a})—O)_{q}—H with q=1 and R^{a}=H or C₁₋₆-alkyl. Especially preferably, R⁵ is selected from H, C₁₋₆-alkyl (preferably C₁₋₁₆-alkyl, for example methyl, ethyl, n-propyl or isopropyl), C₁₋₆-hydroxyalkyl and C₃₋₆-alkenyl (preferably allyl).

In a preferred embodiment, R⁵ is selected from H, C₁₋₂₀-alkyl, C₁₋₂₀-hydroxyalkyl and —(CH₂—CH(R^{a})—O)_{q}—H with q=1-20 and R^{a}=H or C₁₋₆-alkyl; preferably, q=1 and R^{a}=H or C₁₋₄-alkyl. It is often preferable that R⁵ is selected from C₁₋₁₂-alkyl; C₁₋₁₂-hydroxyalkyl and —(CH₂—CH(R^{a})—O)_{q}—H with q=1 and R^{a}=H or C₁₋₆-alkyl. Especially preferably, R⁵ is selected from H and C₁₋₁₂-alkyl (preferably C₁₋₁₆-alkyl, for example methyl, ethyl, n-propyl or isopropyl).

In a particularly preferred embodiment, R⁵=methyl.

Preferably, R⁶ is selected from H; OH; C₁₋₂₀-alkyl; C₁₋₂₀-hydroxyalkyl; —O—C(═O)R^{b} with R^{b}=H, C₁₋₂₀-alkyl, C₂₋₂₀-alkenyl, C₂₋₂₀-alkynyl, C₆₋₂₀-aryl or C₇₋₃₂-arylalkyl; —O—C(═O)—(CH₂)ₘ—C(═O)—O—R^{c}; —O—C(═O)—Y—C(═O)—O—Rb, where m=1-10, R^{c}=H, C₁₋₂₀-alkyl, C₂₋₂₀-alkenyl, C₂₋₂₀-alkynyl, C₆₋₂₀-aryl, C₇₋₃₂-arylalkyl or 1,2,2,6,6-pentamethylpiperidin-4-yl and Y is a C₂₋₁₀-alkenylene group; —O—R^{d} with R^{d}=C₂₋₂₀-alkenyl, C₂₋₂₀-alkynyl, C₆₋₂₀-aryl, C₇₋₃₂-arylalkyl or 1,2,2,6,6-pentamethyl-piperidin-4-yl; —NR^{x}R^{y}, —N(R^{x})—C(═O)R^{y}; —N(R^{x})—C(═O)—Y—C(═O)—O—R^{y}; —N(R^{x})—(CH₂)ᵣ—NR^{y}R^{z}, where R^{x}, R^{y} and R^{z} are each independently H, C₁₋₂₀-alkyl, C₂₋₂₀-alkenyl, C₂₋₂₀-alkynyl, C₆₋₂₀-aryl, C₇₋₃₂-arylalkyl, C₁₋₂₀-hydroxyalkyl, C₁₋₂₀-aminoalkyl or 1,2,2,6,6-pentamethylpiperidin-4-yl, r=1-10 and Y is a C₂₋₁₀-alkenylene group; —(O—CH₂—CH(R^{e})—(CH₂)ᵢ)ₚ—O—R^{e′} with p=1-20, i=0 or 1, R^{e}=H, OH or C₁₋₆-alkyl and R^{e′}=H or C₁₋₈-alkyl; —S—R^{f}; —S—S—R^{f} with R^{f}=H, C₁₋₂₀-alkyl, C₂₋₂₀-alkenyl, C₆₋₂₀-aryl or C₇₋₃₂-arylalkyl; or two R⁶ radicals together with the carbon atom to which they are bonded form a —C—(O—CH₂—CH₂—O)—, —C—(O—CH₂—CH₂—CH₂—O)—, —C—(O—C(CH₃)₂—C(CH₃)₂—O)— or —C—(NH—C(═O)—NH—C(═O))— ring.

Especially preferably, R⁶ is selected from H, OH; —O—C(═O)R^{b} with R^{b}=H or C₁₋₂₀-alkyl; —O—C(═O)—(CH₂)ₙ—C(═O)—O—R^{c} with n=1-3, preferably n=1 and R^{c}=H, C₁₋₁₈-alkyl or 1,2,2,6,6-pentamethylpiperidin-4-yl; —O—R^{d} with R^{d}=C₂₋₁₈-alkenyl; —NR^{x}R^{y}, where R^{x} and R^{y} are each independently H, C₁₋₁₈-alkyl, C₁₋₁₈-hydroxyalkyl or C₁₋₁₈-aminoalkyl.

More particularly R⁵ and/or R⁶ may be —(O—CH₂—CH(R^{e})—(CH₂)ᵢ)ₚ—O—R^{e′} with p=1-20, i=0 or 1, R^{e}=H, OH or C₁₋₆-alkyl and R^{e′}=H or C₁₋₈-alkyl. More particularly R⁵ and/or R⁶ may be selected from the group consisting of —O—(CH₂—CH₂—O)ₚ-R^{e′}, —O—(CH₂—CH(CH₃)—O)ₚ—R^{e′} and —O—(CH₂—CHOH—CH₂—O)ₚ-R^{e′} with p=1-20, R^{e′}=H or C₁₋₈-alkyl.

Preferably, the —NR^{x}R^{y} or —N(R^{x})—(CH₂)ᵣ—NR^{y}R^{z} group may be selected from one of the following groups:

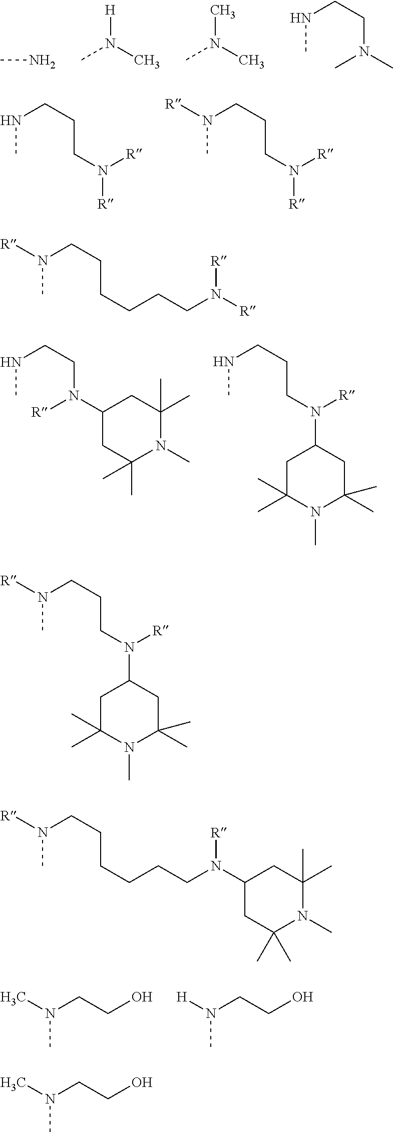

with R″=H or C₁₋₄-alkyl, preferably H or methyl.

Preferably, the —C—(O—CH₂—CH₂—O)— or —C—(NH—C(═O)—NH—C(═O))— rings which are formed from two R⁶ radicals and the carbon atom to which the R⁶ radicals are bonded have the following structure:

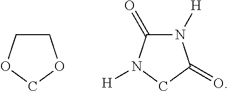 [SMILES: C1COCO1 ; O=C1CNC(=O)N1]

In a particularly preferred embodiment, R⁶=OH.

In a preferred embodiment of the invention, the composition comprises at least one stabilizer S of the formula (I) where the radicals are each defined as follows:
Z is a bivalent group comprising 2 to 5 groups selected from C(R⁶)₂, N—R′ and C═O, where the Z group forms a 5- to 8-membered ring together with the carbon atoms C¹, C² and the nitrogen atom N, where R′ is selected from H, C₁₋₁₈-alkyl and C₁₋₁₈-hydroxyalkyl;
   where R⁶ is selected from H; OH; CN; C₁₋₂₀-alkyl, C₁₋₂₀-hydroxyalkyl; —O—C(═O)Rb with R^{b}=H, C₁₋₂₀-alkyl, C₂₋₂₀-alkenyl, C₂₋₂₀-alkynyl, C₆₋₂₀-aryl or C₇₋₃₂-arylalkyl; —O—C(═O)—(CH₂)ₘ—C(═O)—O—R^{c}, where m=1-10, R^{c}=H, C₁₋₂₀-alkyl, C₂₋₂₀-alkenyl, C₂₋₂₀-alkynyl, C₆₋₂₀-aryl, C₇₋₃₂-arylalkyl or 1,2,2,6,6-pentamethylpiperidin-4-yl; —O—R^{d} with R^{d}=C₂₋₂₀-alkenyl, C₂₋₂₀-alkynyl, C₆₋₂₀-aryl, C₇₋₃₂-arylalkyl or 1,2,2,6,6-pentamethylpiperidin-4-yl; —NR^{x}R^{y}, where R^{x} and R^{y} are each independently H, C₁₋₂₀-alkyl, C₂₋₂₀-alkenyl, C₆₋₂₀-aryl, C₇₋₃₂-arylalkyl, C₁₋₂₀-hydroxyalkyl or C₁₋₂₀-aminoalkyl;
   or where two R⁶ radicals together with the carbon atom to which they are bonded form a —C—(O—CH₂—CH₂—O)—, —C—(O—CH₂—CH₂—CH₂—O)—, —C—(O—C(CH₃)₂—C(CH₃)₂—O)— or —C—(NH—C(═O)—NH—C(═O))— ring;
R¹, R², R³ and R⁴
   are each independently selected from C₁₋₂₀-alkyl, C₂₋₂₀-alkenyl and C₇₋₃₂-arylalkyl; preferably C₁₋₂₀-alkyl;
R⁵ is H; C₁₋₂₀-alkyl; C₂₋₂₀-alkenyl; C₇₋₃₂-arylalkyl; C₁₋₂₀-hydroxyalkyl; C₁₋₂₀-cyanoalkyl; C₁₋₂₀-sulfoalkyl; C₁₋₂₀-phosphonoalkyl; —(CH₂—CH(R^{a})—O)_{q}—H with q=1-20 and R^{a}=H or C₁₋₆-alkyl; —C(═O)—R^{h} with R^{h}=H, C₁₋₂₀-alkyl, C₂₋₂₀-alkenyl, C₆₋₂₀-aryl or C₇₋₂₀-arylalkyl; 2,2,6,6-tetramethyl-4-piperidinol-1-ylalkyl or 4-(2,2,6,6-tetramethyl-4-piperidinol-1-ylalkyl)benzyl.

Preferably, the invention relates to compositions where at least one stabilizer S selected from compounds of the formulae (II) to (IV) is present:

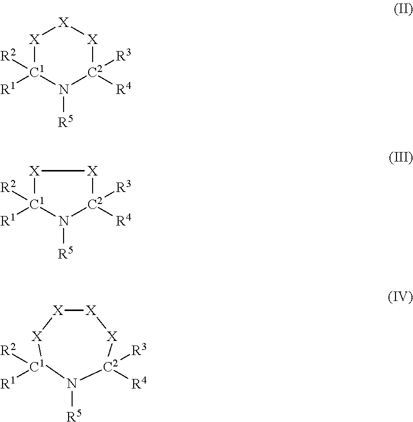

where X is independently a group selected from C(R⁶)₂, N—R′ and C═O, and where the R¹, R², R³, R⁴, R⁵, R⁶ and R′ radicals are each as defined above.

For the stabilizer S selected from compounds of the formulae (II) to (IV), the above-described preferred embodiments of the R¹, R², R³, R⁴, R⁵, R⁶ and R radicals apply.

Preferably, the invention relates to compositions where at least one stabilizer S selected from compounds of the formulae (X1) to (X5) is present:

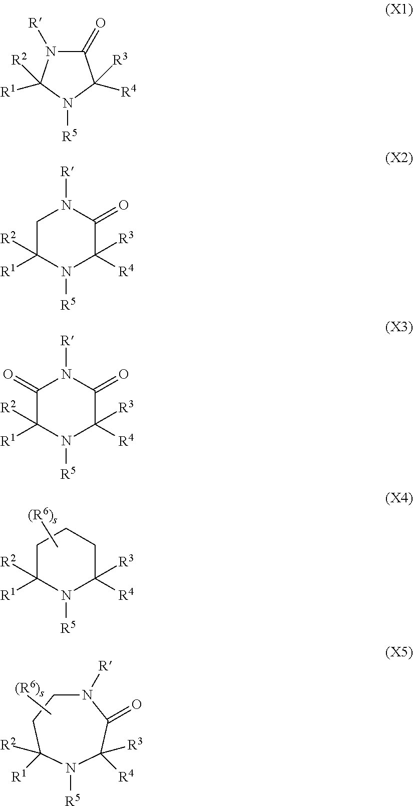

where the R¹, R², R³, R⁴, R⁵, R⁶ and R′ radicals are each as defined above and s is a number from 0 to 6, preferably from 1 to 3, especially preferably 1.

For the stabilizer S selected from compounds of the formulae (X1) to (X5), the above-described preferred embodiments of the R¹, R², R³, R⁴, R⁵, R⁶ and R′ radicals apply.

Especially preferred are compounds of the formula (X4). Especially preferred are compounds of the formula (X4) comprising exactly one R⁶ radical in the 4 position, where R⁶ is not H.

Preferably, in the compounds of the formulae (X1) to (X5), R¹=R² and R³=R⁴; especially preferably, R¹=R²=R³=R⁴. Preferably, R¹=R² and R³=R⁴ are methyl, ethyl, n-propyl or isopropyl, especially preferably methyl.

Preferably, in compounds of the formulae (X1) to (X5), R⁵ is selected from C₁₋₁₂-alkyl (for example methyl, ethyl, n-propyl or isopropyl); C₂₋₁₂-alkenyl (for example allyl); C₇₋₂₀-arylalkyl (for example benzyl); C₁₋₁₂-cyanoalkyl (for example cyanomethyl); C₁₋₁₂-sulfoalkyl (for example 3-sulfopropyl); C₁₋₁₂-phosphonoalkyl (for example phosphonatomethyl); —(CH₂—OH(R^{d})—O)_{q}—H with q=1-10, preferably 1-5, especially preferably 1 and R^{a}=H or C₁₋₆-alkyl; —O(═O)—R^{h} with R^{h}=C₁₋₁₂-alkyl; 2,2,6,6-tetramethyl-4-piperidinol-1-ylalkyl and 4-(2,2,6,6-tetramethyl-4-piperidinol-1-yl-alkyl)benzyl.

Preferably, in compounds of the formulae (X1) to (X5), R⁶ is selected from H; OH; —O—O(═O)Rb with R^{b}=H or C₁₋₂₀-alkyl; —O—O(═O)—(CH₂)ₘ—C(═O)—O—R^{c} with m=1-3, preferably m=1 and R^{c}=H, C₁₋₂₀-alkyl or 1,2,2,6,6-pentamethylpiperidin-4-yl; —O—R^{d} with R^{d}=C₂₋₂₀-alkenyl; —NR^{x}R^{y} where R^{x} and R^{y} are each independently H, C₁₋₂₀-alkyl, C₁₋₂₀-hydroxyalkyl or C₁₋₂₀-aminoalkyl;

or two R⁶ radicals together with the carbon atom to which they are bonded form a —C—(O—CH₂—CH₂—O)— or —C—(NH—O(═O)—NH—O(═O))— ring. Preferably, in compounds of the formulae (X1) to (X5), R⁶=—OH.

Preferably, in compounds of the formulae (X1) to (X5), R is selected from H, C₁₋₂₀-alkyl and C₁₋₂₀-hydroxyalkyl; preferably, R′=H.

Preference is given to using a stabilizer S selected from compounds of the formula (V):

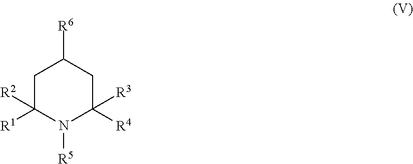

where the R¹, R², R³, R⁴, R⁵ and R⁶ radicals have the definitions described above.

For the stabilizer S of the formula (V), the above-described preferred embodiments of the R¹, R², R³, R⁴, R⁵ and R⁶ radicals apply.

Particular preference is given to compounds of the formula (V) where the radicals are each defined as follows:
R¹, R², R³ and R⁴
   are each independently selected from C₁₋₆-alkyl, preferably selected from methyl, ethyl, n-propyl or isopropyl, more preferably methyl;
R⁵ is selected from H; C₁₋₂₀-alkyl; C₂₋₂₀-alkenyl; C₇₋₃₂-arylalkyl; C₁₋₂₀-hydroxyalkyl; C₁₋₂₀-cyanoalkyl; C₁₋₂₀-sulfoalkyl; C₁₋₂₀-phosphonoalkyl; —(CH₂—CH(R^{a})—O)_{q}—H with q=1-20 and R^{a}=H or C₁₋₆-alkyl; —C(═O)—R^{h} with R^{h}=H, C₁₋₂₀-alkyl, C₂₋₂₀-alkenyl, C₆₋₂₀-aryl or C₇₋₂₀-arylalkyl; 2,2,6,6-tetramethyl-4-piperidinol-1-ylalkyl and 4-(2,2,6,6-tetramethyl-4-piperidinol-1-ylalkyl)benzyl;
   more preferably, R⁵ is selected from H, C₁₋₁₂-alkyl or —(CH₂—CH(R^{a})—O)_{q}—H with q=1 and R^{a}=H or C₁₋₆-alkyl; especially preferably from C₁₋₁₂-alkyl or —(CH₂—CH(R^{a})—O)_{q}—H with q=1 and R^{a}=H or C₁₋₆-alkyl;
R⁶ is selected from H; OH; C₁₋₂₀-alkyl; C₁₋₂₀-hydroxyalkyl; —O—O(═O)R^{b} with R^{b}=H, C₁₋₂₀-alkyl, C₂₋₂₀-alkenyl, C₆₋₂₀-aryl, or C₇₋₃₂-arylalkyl; —O—O(═O)—(CH₂)ₘ—C(═O)—O—R^{c} with m=1-10 and R^{c}=H, C₁₋₂₀-alkyl, C₂₋₂₀-alkenyl, C₆₋₂₀-aryl, C₇₋₃₂-arylalkyl or 1,2,2,6,6-pentamethylpiperidin-4-yl; —O—R^{d} with R^{d}=C₂₋₂₀-alkenyl, C₂₋₂₀-aryl, C₆₋₂₀-aryl, C₇₋₃₂-arylalkyl or 1,2,2,6,6-pentamethylpiperidin-4-yl; —NR^{x}R^{y} where R^{x} and R^{y} are each independently H, C₁₋₂₀-alkyl, C₂₋₂₀-alkenyl, C₆₋₂₀-aryl, C₇₋₃₂-arylalkyl, C₁₋₂₀-hydroxyalkyl or C₁₋₂₀-aminoalkyl.

Particular preference is given to compounds of the formula (V) where the radicals are each defined as follows:
R¹=R² and R³=R⁴ are selected from methyl, ethyl, n-propyl or isopropyl; especially preferably R¹=R²=R³=R⁴=methyl.
R⁵ is selected from H, C₁₋₁₂-alkyl (for example methyl, ethyl, n-propyl or isopropyl) and —(CH₂—CH(R^{a})—O)_{q}—H with q=1 and R^{a}=H or C₁₋₆-alkyl; especially preferably from C₁₋₁₂-alkyl or —(CH₂—CH(R^{a})—O)_{q}—H with q=1 and R^{a}=H or C₁₋₆-alkyl;
R⁶ is selected from H, OH; —O—O(═O)R^{b} with R^{b}=H or C₁₋₂₀-alkyl; —O—O(═O)—(CH₂)ₘ—C(═O)—O—Rb with m=1-3 (preferably m=1) and R^{c}=H, C₁₋₁₈-alkyl and 1,2,2,6,6-pentamethylpiperidin-4-yl; —O—R^{d} with R^{d}=C₂₋₂₀-alkenyl; —NR^{x}R^{y} where R^{x} and R^{y} are each independently H, C₁₋₂₀-alkyl, C₁₋₂₀-hydroxyalkyl or C₁₋₂₀-aminoalkyl.

Particular preference is given to compounds of the formula (V) with R⁶=OH.

Especially preferred are stabilizers of the formula (VI);

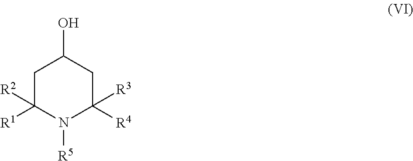

where the R¹, R², R³, R⁴ and R⁵ radicals have the definitions described above.

For the stabilizer S of the formula (VI), the above-described preferred embodiments of the R¹, R², R³, R⁴ and R⁵ radicals apply.

Particular preference is given to compounds of the formula (VI) where the radicals are each defined as follows:
R¹, R², R³ and R⁴
   are each independently selected from C₁₋₆-alkyl, preferably selected from methyl, ethyl, n-propyl or isopropyl, more preferably methyl;
R⁵ is H; C₁₋₂₀-alkyl; C₂₋₂₀-alkenyl; C₇₋₃₂-arylalkyl; C₁₋₂₀-hydroxyalkyl; C₁₋₂₀-cyanoalkyl; C₁₋₂₀-sulfoalkyl; C₁₋₂₀-phosphonoalkyl; —(CH₂—CH(R^{a})—O)_{q}—H with q=1-20 (preferably q=1-5) and R^{a}=H or C₁₋₆-alkyl; —C(═O)—R^{h} with R^{h}=H, C₁₋₂₀-alkyl, C₂₋₂₀-alkenyl, C₆₋₂₀-aryl or C₇₋₂₀-arylalkyl; 2,2,6,6-tetramethyl-4-piperidinol-1-ylalkyl and 4-(2,2,6,6-tetramethyl-4-piperidinol-1-ylalkyl)benzyl;
   more preferably, R⁵ is selected from H, C₁₋₁₂-alkyl or —(CH₂—CH(R^{a})—O)_{q}—H with q=1 and R^{a}=H or C₁₋₆-alkyl; especially preferably from C₁₋₁₂-alkyl or —(CH₂—CH(R^{a})—O)_{q}—H with q=1 and R^{a}=H or C₁₋₆-alkyl.

Particular preference is given to compounds of the formula (VI) where the radicals are each defined as follows:
R¹, R², R³ and R⁴
   are each independently selected from C₁₋₆-alkyl, preferably selected from methyl, ethyl, n-propyl or iso-propyl, more preferably methyl;
R⁵ is H; C₁₋₁₂-alkyl; C₂₋₁₂-alkenyl; C₁₋₆-hydroxyalkyl or —(CH₂—CH(R^{a})—O)_{q}—H with q=1 and R^{a}=H or C₁₋₆-alkyl;

Particular preference is given to compounds of the formula (VI) where the radicals are each defined as follows:
R¹, R², R³ and R⁴ are methyl;
R⁵ is C₁₋₁₂-alkyl; —CH₂—CH(R^{a})—O—H with R^{a}=H or C₁₋₆-alkyl.

More particularly, it is possible to use one or more of the following compounds V1 to V56 as the stabilizer S:

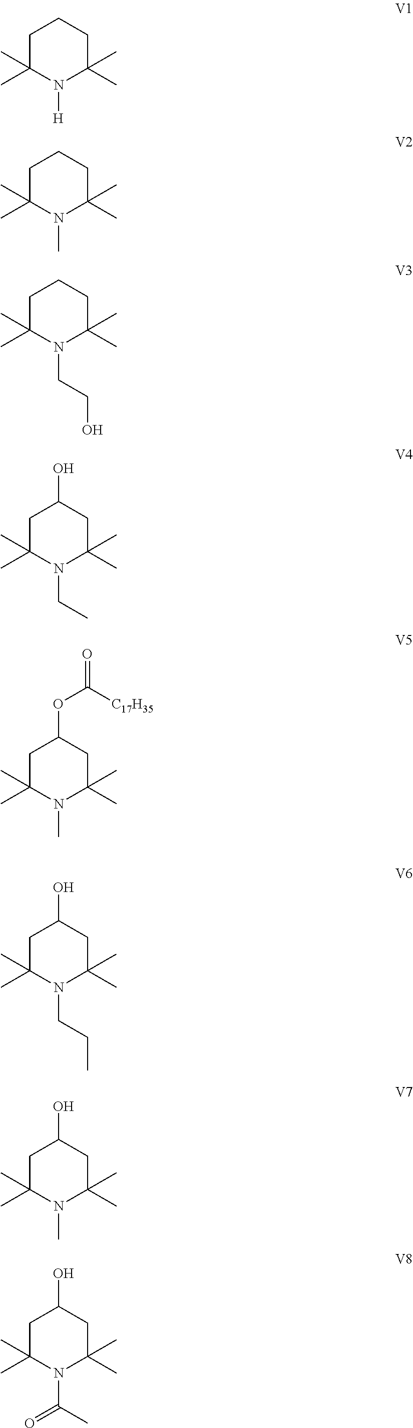

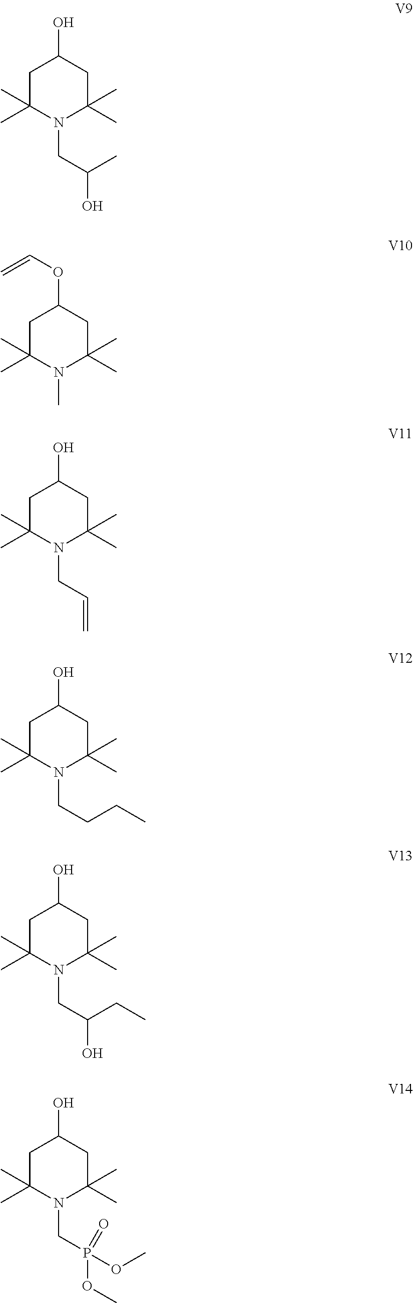

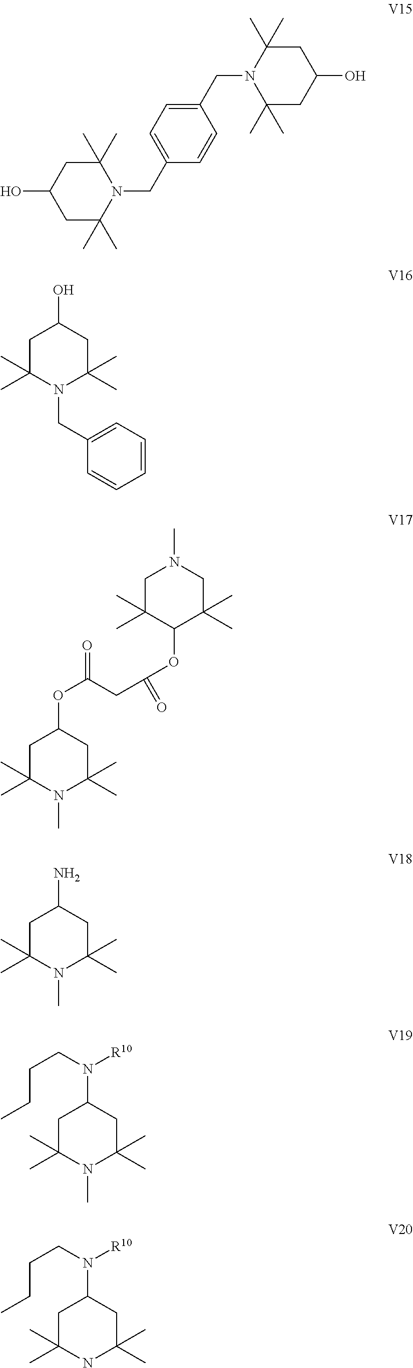

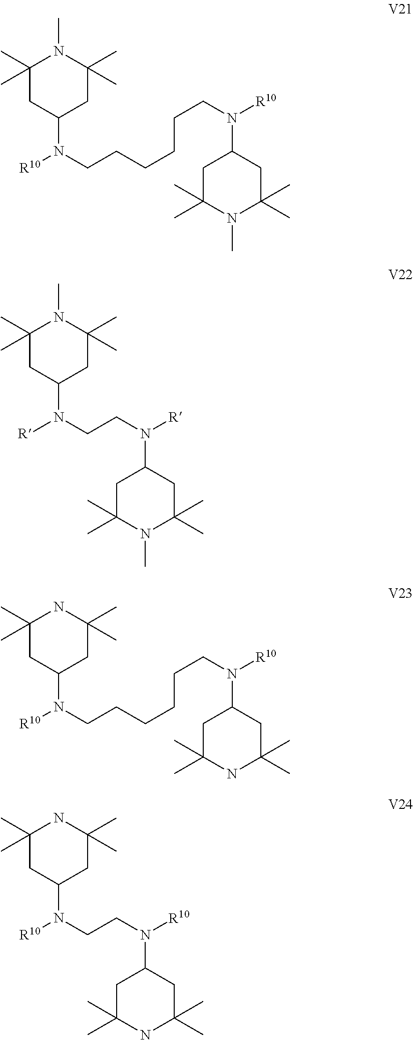

with R10=H or C1-C8-alkyl

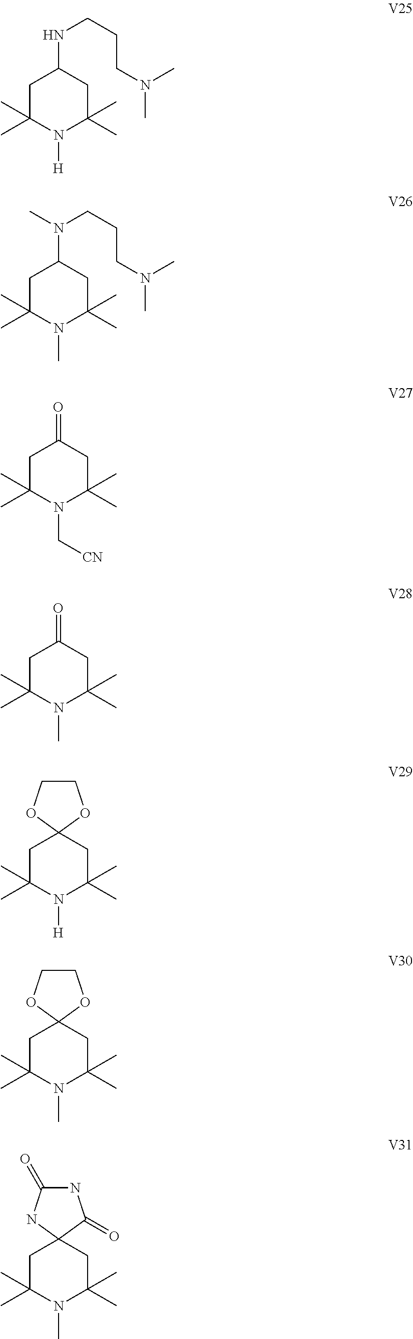

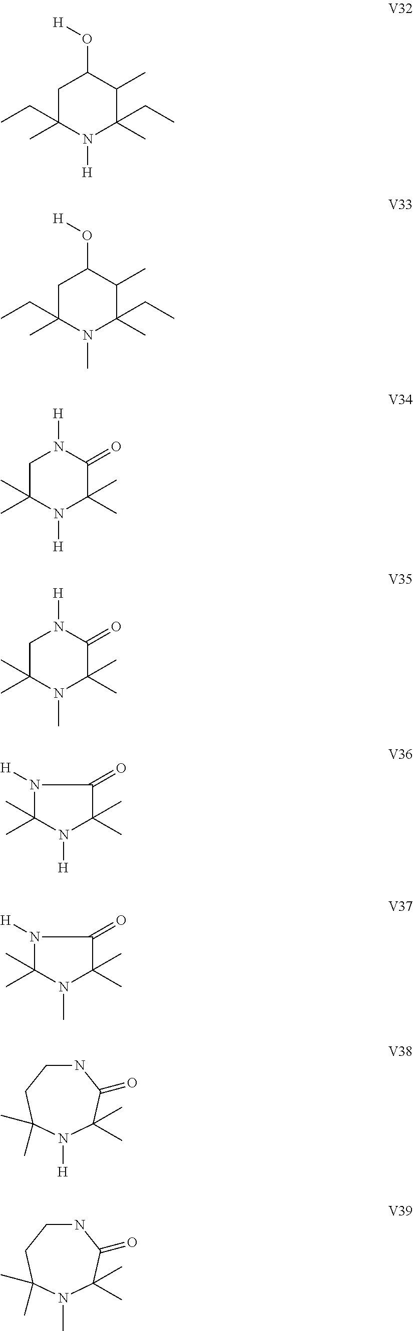

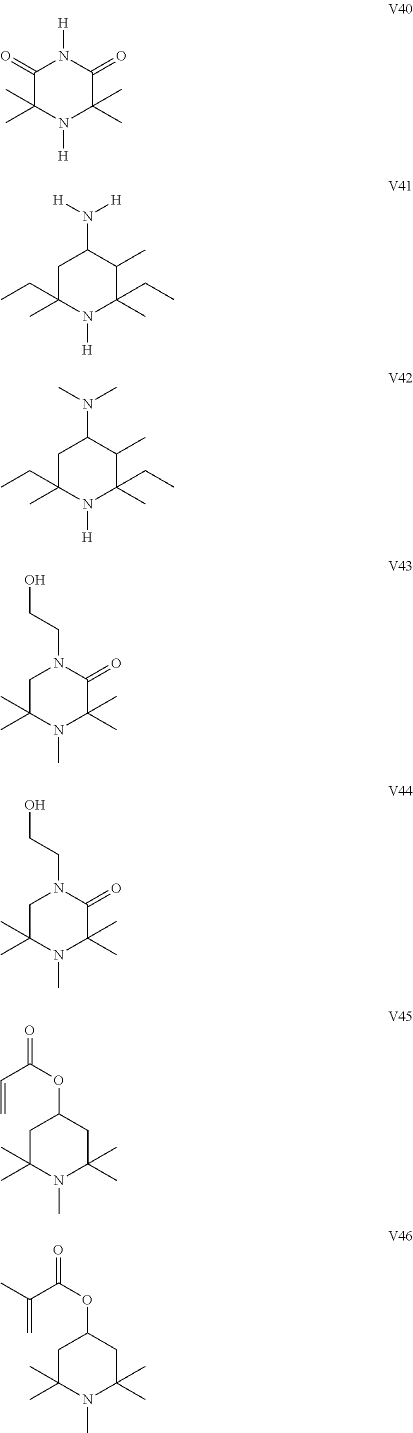

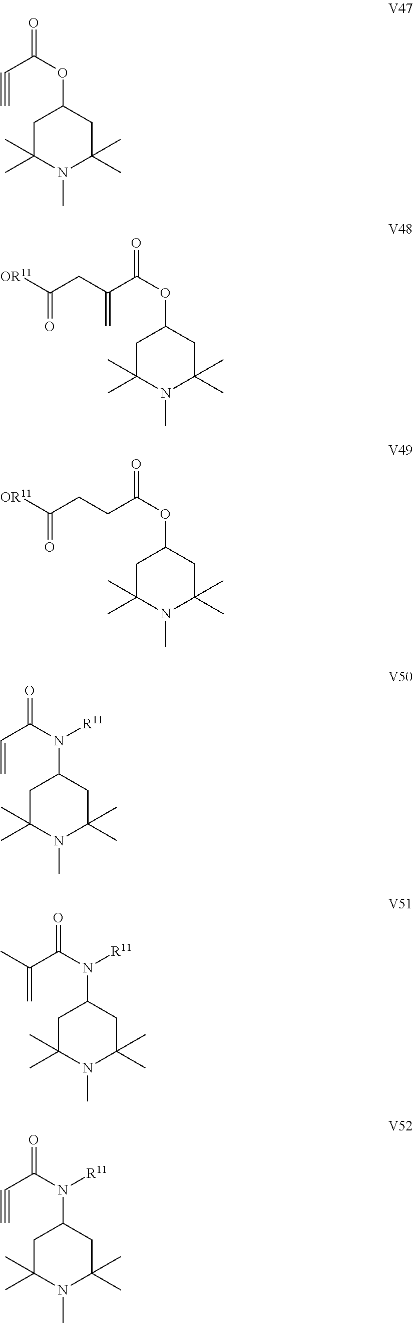

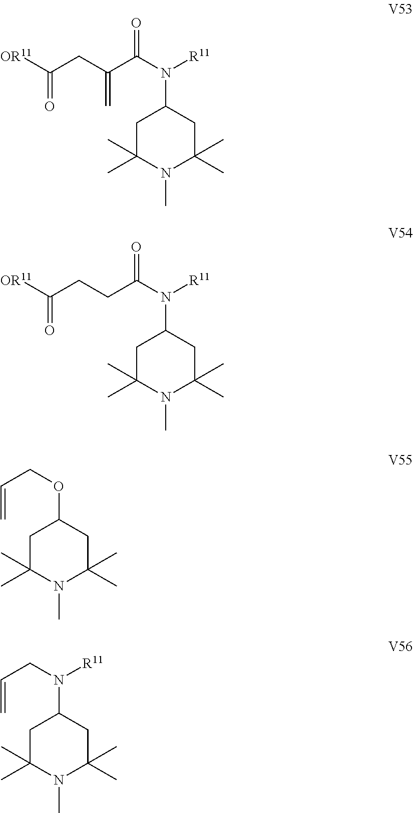

with R11=H, C1-C8-alkyl or 1,2,2,6,6-pentamethylpiperidin-4-yl

Preference is given to the use of at least one compound selected from V4, V7, V8, V9, V11 and V13 as stabilizer S.

Particular preference is given to the use of 1,2,2,6,6-pentamethyl-4-piperidinol (V7) as stabilizer S

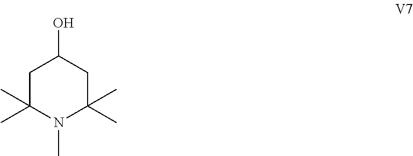

1,2,2,6,6-Pentamethyl-4-piperidinol can be used alone or in combination with one or more compounds of the formulae (I) to (V) and (X1) to (X5), especially with one or more compounds V1 to V6 and V8 to V56, as described above, as stabilizer S.

Preferably, the stabilizer used is exclusively one or more of the above-described stabilizers S. However, it is also possible to combine the above-described stabilizer S with other known stabilizers, for example sacrificial reagents (such as alcohols) or other HALS compounds (e.g. Tinuvin 292, Sabostab UV 119, Hostavin PR 31, ADK STAB LA-52, Tinuvin 765, Cyasorb UV3529, Cyasorb UV3641, Hostavin N30, Goodrite UV3159).

Preferably, the invention relates to an above-described composition comprising (in particular is composed of):
0.01 to 99% by weight, preferably 0.05 to 99.9% by weight of at least one above-described acrylamide polymer P;
1 to 10 000 ppm, preferably 10 to 1 000 ppm of at least one above-described stabilizer S,
optionally 0 to 99.99% by weight, preferably 0 to 99.95% by weight of at least one further component, for example a solvent.

Preferably, the invention relates to an above-described composition comprising (in particular is composed of):
98 to 99.9999% by weight, preferably 99 to 99.9% by weight of at least one above-described acrylamide polymer P,
1 to 20 000 ppm, preferably 1 000 to 10 000 ppm of at least one above-described stabilisator S.

### Aqueous Composition

In a particularly preferred embodiment, the invention relates to an aqueous composition comprising at least one acrylamide polymer P and at least one stabilizer S of the formula (I)

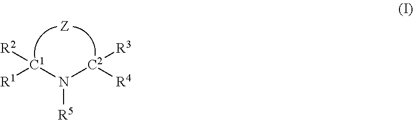

where the radicals have the definitions described above. The above-described preferred embodiments of the acrylamide polymer P and of the stabilizer S apply correspondingly to the inventive aqueous composition.

More particularly, the composition may comprise 70 to 99.95% by weight of water, preferably 90 to 99.95% by weight, especially preferably 99.5 to 99.95% by weight of water. The water may especially be tapwater, groundwater, saltwater (such as seawater), formation water or mixtures thereof.

Preferably, the inventive aqueous formulation comprises 0.01 to 10% by weight of at least one acrylamide polymer P, preferably 0.05 to 0.5% by weight, based on the overall aqueous formulation.

Preferably, the inventive aqueous formulation comprises 1 to 1000 ppm of at least one above-described stabilizer S, preferably 10 to 100 ppm, based on the overall aqueous formulation.

In the context of the present invention, ppm means mg/kg.

Especially preferably, the invention relates to an aqueous composition comprising 0.01 to 10% by weight of at least one above-described acrylamide polymer P and 1 to 1000 ppm of at least one above-described stabilizer S.

In one embodiment of the invention, the aqueous composition may comprise one or more further known stabilizers (light, UV and/or heat stabilizers), for example reducing agents (such as sulfite, bisulfites, metabisulfites, dithionite, hydrazine), precipitants (such as phosphates, hydrogenphosphates, phytic acid), free-radical scavengers (such as thioureas, alkylthioureas, mercaptobenzoimidazoles (MBI), mercaptobenzothiazoles (MBT), thiocyanates, butylhydroxyanisoles, para-methoxyphenol, quinoline), “sacrificial reagents” (primary and secondary mono-, di- and polyalcohols, such as glycerol, propylene glycol, trimethylene glycol, isopropanol, 1,2-butanediol, 1,3-butanediol, 1,4-butanediol, 2,3-butanediol, 1,2,4-butanetriol, pentaerythritol (PETA), trimethylolethane, neopentyl glycol, 1,2-pentanediol, 2,4-pentanediol, 2,3-pentanediol, trimethylolpropane, 1,5-pentanediol, partly or fully hydrolyzed polyvinyl alcohol), complexing agents (polymers such as polyacrylates, polyacetates, polycarboxylates, polyaspartates, polyphosphates, polysuccinates, or smaller anionic compounds such as ascorbic acid, citric acid, dicarboxymethylglutamic acid, ethylenediaminedisuccinic acid (EDDS), ethylenediaminetetraacetic acid (EDTA), diethylenetriaminepentamethylenephosphonic acid (DTPMP), maleic acid, nitrilotriacetic acid, oxalic acid, amino acids, succinic acid, diethylene-triaminepentaacetic acid, disodium malonate etc.) and other HALS compounds (e.g. Tinuvin 292, Sabostab UV 119, Hostavin PR 31, ADK STAB LA-52, Tinuvin 765, Cyasorb UV3529, Cyasorb UV3641, Hostavin N30, Goodrite UV3159). Customary stabilizers are described, for example, in WO 2010/133258. Especially preferably, the composition, especially the aqueous composition, comprises at least one abovementioned “sacrificial reagent”. The use of secondary monoalcohols, for example isopropanol (2-propanol), is especially preferred.

A preferred embodiment of the invention relates to an aqueous composition comprising:
70 to 99.99% by weight, preferably 90 to 99.95% by weight, especially preferably 99.5 to 99.98% by weight,
   of water;
0.01 to 10% by weight, preferably 0.01 to 2% by weight, especially preferably 0.05 to 0.5% by weight, more preferably 0.06 to 0.2% by weight,
   of at least one above-described acrylamide polymer P;
0.1 to 10 000 ppm, preferably 1 to 1000 ppm, especially preferably 10 to 100 ppm,
   of at least one above-described stabilizer S;
optionally 0 to 30% by weight, preferably 0 to 1% by weight, especially preferably 0 to 0.1% by weight, more preferably 10 to 500 ppm,
   of at least one further additive, especially selected from light, UV and heat stabilizers, preferably selected from mono-, di- and polyalcohols, especially selected from secondary monoalcohols, e.g. isopropanol;
      where all FIGURES in % by weight or ppm relate to the overall aqueous composition.

A preferred embodiment relates to an above-described composition where the amounts of the described components (in % by weight and/or ppm) add up to 100%.

A preferred embodiment relates to an above-described composition where the percentages by weight add up to 100%, More particularly, the invention relates to a composition consisting of the abovementioned components.

### Process for Production

The present invention further relates to a process for producing an above-described inventive composition, wherein at least one acrylamide polymer P and at least one stabilizer S are mixed and/or at least one stabilizer S is added before or during the polymerization of the at least one acrylamide polymer P.

The mixing of the acrylamide polymer P and the stabilizer S can especially be effected by mixing the dry components (acrylamide polymer P, stabilizer S and optionally further additives). In another execution, a solution of at least one stabilizer S in a solvent can be applied to (for example sprayed onto) the acrylamide polymer P; optionally, a drying step for removal of the solvent may follow.

In a preferred embodiment, the at least one stabilizer S or a solution of the at least one stabilizer S in a solvent, preferably water, is applied to the acrylamide polymer P, where the acrylamide polymer P is present in the form of a gel, for example as the product of the gel polymerization described below. Preferably, this embodiment comprises the subsequent drying of the gel.

It is also possible to extrude the acrylamide polymer P and the stabilizer S together, for which purpose either the two components are added separately to the extruder or else a dry mix is first produced and then extruded.

In addition, it is possible to add the at least one stabilizer S before or during the polymerization of the acrylamide polymer P. The polymerization of the acrylamide polymer P can be effected, for example, by solution or gel polymerization in the aqueous phase. The acrylamide polymer P can be polymerized, for example, as described in WO 2012/069478 and WO 2010/133527.

In a particularly preferred embodiment, the invention relates to a process for producing an above-described inventive composition, wherein the at least one stabilizer S is added before or during the polymerization of the at least one acrylamide polymer P, i.e. in the course of preparation of the at least one acrylamide polymer P from the corresponding monomers.

It has additionally been found that the above-described stabilizers S can be added even before or during the polymerization of the acrylamide polymer P without any disruptive influence on the polymerization. In fact, it has been found that, surprisingly, the resulting acrylamide polymer P has further advantageous properties when an above-described stabilizer S, especially hydroxypentamethylpiperidine PMP, is added to the monomer solution comprising acrylamide and any further monomers (comonomers) before or during the preparation of the polymer. As well as the stabilization of the acrylamide polymers P against free-radical degradation (storage stability), it is surprisingly possible to achieve the following further advantages:
optimization of the filterability (e.g. Millipore filtration ratio, MPFR) of the acrylamide polymer P;
reduction in the insoluble gel fractions in the acrylamide polymer P;
increase in the viscosity of the resulting polymer solution of the acrylamide polymer P.

The invention preferably relates to a process for producing an above-described inventive composition, wherein the at least one stabilizer S is added before the polymerization of the at least one acrylamide polymer P, and wherein a monomer solution, preferably an aqueous monomer solution, comprising acrylamide, optionally one or more further monomers, especially at least one monomer selected from the above-described monomers a) to d), especially selected from the monomers a) and b), at least one above-described stabilizer S and at least one solvent, especially water, is polymerized.

In connection with the optional further monomers, i.e. the monomers (a) to (d), the abovementioned preferred embodiments apply correspondingly.

More particularly, the monomer solution has a concentration of monomers in the range from 10 to 50% by weight, preferably 20 to 40% by weight, based on the overall monomer solution. The concentration of all the components of the monomer solution except for the solvent, especially water, is typically 10 to 60% by weight, preferably 20 to 50% by weight, more preferably 25 to 40% by weight.

More particularly, the monomer solution has a concentration of stabilizer S in the range from 0.1 to 2% by weight, preferably from 0.2 to 1% by weight, more preferably from 0.2 to 0.8% by weight, especially preferably from 0.3 to 0.8% by weight, based on the total amount of the monomers in the monomer solution.

More particularly, the monomer solution has a concentration of stabilizer S in the range from 0.01 to 1% by weight, preferably from 0.02 to 0.5% by weight, more preferably from 0.02 to 0.4% by weight, especially preferably from 0.03 to 0.4% by weight, based on the overall monomer solution.

The above-described monomer solution preferably comprises a standard initiator for free-radical polymerization, especially selected from peroxide initiators, azo initiators and redox initiators. Typical peroxide initiators are, for example, dibenzoyl peroxide (DBPO), cyclohexylsulfonyl-acetyl peroxide (SPO), diisopropyl peroxydicarbonate (DIPP), butyl peroxypivalate, dilauryl peroxide (D190), tert-butyl hydroperoxide (t-BHP) and cumene hydroperoxide. Typical azo initiators are, for example, 4,4′-azobis-4-cyanovaleric acid (ACVA), 2,2′-azobis(2-methyl-propionamidine) dihydrochloride, 2,2′-azobis(2-methylpropionitrile), 2,2′-azobis(2-methylbutane-nitrile), 2,2′-azobis(2,4-dimethylvaleronitrile), 1,1′-azobis(cyanocyclohexane), 1,1′-azobis(N,N-dimethylformamide), 2,2′-azobis(2-methylbutyronitrile), 2,2′-azobis(4-methoxy-2,4-dimethyl-valeronitrile), 2,2′-azobis(2,4,4-trimethylpentane). Typical redox initiators are, for example, mixtures of an oxidizing agent, such as hydrogen peroxide, peroxodisulfates or abovementioned peroxide compounds, and a reducing agent, such as iron(II) salts, silver(I) salts, cobalt(II) salts, sulfites, hydrogensulfites or thiosulfates. The monomer solution especially comprises 0.01 to 5 ppm, preferably 0.01 to 1 ppm, based on the overall monomer solution, of at least one initiator, especially selected from 4,4′-azobis(4-cyanovaleric acid) (ACVA), azobis(isobutyronitrile) (AIBN), dibenzoyl peroxide (DBPO), tert-butyl hydroperoxide (t-BHP) and redox initiators comprising at least one peroxide compound and at least one sulfite.

As solvent, the monomer solution preferably comprises water, or a mixture of water and one or more suitable water-miscible organic solvents, where the proportion of water is generally at least 50% by weight, preferably at least 80% by weight and more preferably at least 90% by weight, based on the overall solvent. Organic solvents used may be known polar, water-miscible solvents such as alcohols or dimethyl sulfoxide (DMSO). Organic solvents used may especially be water-miscible alcohols such as methanol, ethanol or propanol.

Acidic or basic monomers can be fully or partly neutralized prior to the polymerization. Preferably, the pH of the monomer solution is in the range from 4 to 9, preferably in the range from 5 to 8.

Preference is given to using a monomer solution comprising 10 to 50% by weight, preferably 20 to 40% by weight, of monomers, especially selected from acrylamide and the above-described monomers a) to d); 0.01 to 1% by weight, preferably from 0.02 to 0.5% by weight, of at least one stabilizer S; 0.01 to 5 ppm, preferably 0.01 to 1 ppm, of an abovementioned free-radical initiator and at least one solvent, preferably water, where all the FIGURES relate to the overall monomer solution. In a preferred embodiment, the components mentioned add up to 100% by weight. The at least one solvent, preferably water, is present typically in an amount of 49 to 89.99% by weight, preferably 59.5 to 79.98% by weight, based on the overall monomer solution.

Preferably, the polymerization of the monomer solution is effected by means of gel polymerization, preferably by means of adiabatic gel polymerization. The invention preferably relates to a process wherein at least one stabilizer S is added before or during the polymerization of the at least one acrylamide polymer P, and wherein the polymerization is effected by means of adiabatic gel polymerization of an aqueous monomer solution comprising acrylamide; optionally one or more further monomers (especially at least one monomer selected from the above-described monomers a) and d), preferably from a) and b)), at least one above-described stabilizer S and at least one solvent. Typically, in the gel polymerization, a concentrated monomer solution, especially an aqueous monomer solution, is used. Typically, the monomer solution is cooled to −5° C. to 0° C., preferably to about 0° C., and then polymerized photochemically and/or thermally. Preference is given to effecting the polymerization by addition of suitable initiators for free-radical polymerization, e.g. peroxides (such as tert-butyl hydroperoxide), azo compounds (such as azobis(isobutyronitrile)) or redox initiators. The photochemical polymerization is initiated typically at temperatures of −5 to 10° C.; the thermal polymerization is initiated typically at temperatures of −5 to 50° C. Preferably, photochemical and thermal polymerization may be combined with one another.

Typically, the monomer solution or the reaction mixture is not stirred during the polymerization.

During the polymerization, the temperature generally rises to about 80 to 95° C. on account of the heat of reaction. Typically, a polymer gel is obtained, which can then be comminuted, dried and/or ground. The drying should preferably be effected at temperatures below 100° C. To avoid conglutination, a suitable separating agent can be used for this step. The acrylamide polymer P is obtained as a powder.

The invention preferably relates to a process as described, wherein the at least one stabilizer S is added before or during the polymerization of the at least one acrylamide polymer P, and wherein the polymerization is effected by means of adiabatic gel polymerization of an aqueous monomer solution comprising acrylamide; optionally one or more further polymers; 0.1 to 2% by weight, preferably from 0.2 to 1% by weight, more preferably from 0.2 to 0.8% by weight, especially preferably from 0.3 to 0.8% by weight, based on the total amount of the monomers in the monomer solution, of at least one stabilizer S; and at least one solvent comprising at least 50% by weight of water, based on the overall solvent.

Further details of the performance of a gel polymerization are described, for example, in WO 2010/133527 (pages 18 and 19) and DE 10 2004 032 304 A1 (paragraphs [0037] to [0041]).

It is additionally possible that the polymerization of the monomer solution is effected by means of emulsion polymerization. The performance of an emulsion polymerization for preparation of acrylamide polymers is disclosed, for example, by WO 2009/019225, page 5 line 16 to page 8 line 13.

In one embodiment, it is possible to add the stabilizer S, optionally in the form of a solution, to the crude acrylamide polymer product directly after the polymerization, more particularly before the workup and/or drying of the acrylamide polymer P. For example, the stabilizer S can be applied to, for example sprayed onto, an acrylamide polymer gel P (crude acrylamide polymer product) obtained after the gel polymerization. More particularly, the stabilizer S, optionally in the form of a solution, can be applied to for example sprayed onto, comminuted gel particles after the gel polymerization of the acrylamide polymer P.

In addition, it is possible to add the stabilizer S, optionally in the form of a solution, during the workup of the acrylamide polymer, for example during the drying after the gel polymerization.

The stabilizer can especially be applied to the acrylamide polymer P in the form of a solution, in which case the solvent used is preferably water, or a mixture of water and one or more suitable water-miscible organic solvents, where the proportion of water is generally at least 50% by weight, preferably at least 80% by weight and more preferably at least 90% by weight, based on the overall solvent. Organic solvents used may be known polar, water-miscible solvents, such as alcohols or dimethyl sulfoxide (DMSO). Organic solvents used may especially be water-miscible alcohols such as methanol, ethanol or propanol. The stabilizer S can especially be applied to the acrylamide polymer P in the form of a solution, where the stabilizer S is present in this solution typically within the range from 1 to 50% by weight, preferably from 2 to 30% by weight, especially preferably from 2 to 15% by weight, based on the total amount of the solution. More particularly, the invention relates to a process for producing the above-described inventive composition wherein at least one of the following steps is included: mixing the stabilizer S with the acrylamide polymer P; extruding a mixture of acrylamide polymer P and stabilizer S; applying, for example spraying, a solution of the stabilizer S in a solvent (on) to an acrylamide polymer P; adding the stabilizer S before or during the polymerization of the acrylamide polymer P. The acrylamide polymer P may, for example, be a solid acrylamide polymer P and/or an acrylamide polymer gel P. More particularly, as described above, solid acrylamide polymer P is understood to mean the worked-up and dried product of the above-described gel polymerization, the solid acrylamide polymer P preferably being a powder. More particularly, as described above, acrylamide polymer gel P (crude acrylamide polymer product) is understood to mean the crude product of a gel polymerization. The stabilizer S may, for example, be in the form of a solid, liquid or solution.

More particularly, the invention relates to a process for producing the above-described inventive composition, wherein at least one of the following steps is included: mixing the stabilizer S with a solid acrylamide polymer P; extruding a mixture of a solid acrylamide polymer P and stabilizer S; applying (e.g. spraying) a solution of the stabilizer S in a solvent onto a solid acrylamide polymer P; applying (e.g. spraying) a solution of the stabilizer S in a solvent to an acrylamide polymer gel P, adding the stabilizer S, especially in solid form or in the form of a solution, during the drying of an acrylamide polymer gel P, especially after a gel polymerization and optionally after comminution of the gel obtained, adding the stabilizer S before during the polymerization of the acrylamide polymer P.

It is additionally possible optionally to add one or more abovementioned additives, e.g. light, UV and/or heat stabilizers, such as reducing agents, oxygen scavengers, precipitants, “sacrificial reagents”, especially primary or secondary mono-, di- or polyalcohols, in the above-described process for producing the composition. The addition of the optional additives can be effected, for example, together with the stabilizer S.

The inventive aqueous composition is preferably produced by dissolving the at least one acrylamide polymer P and the at least one stabilizer S and optionally further additives in water.

The present invention additionally relates to the use of an above-described inventive composition in tertiary mineral oil production, especially in polymer flooding.

The above-described embodiments of the acrylamide polymer P, of the stabilizer Sand of the optional further additives apply correspondingly to the process for producing the composition and to the use of the composition.

The present invention additionally relates to the use of an above-described stabilizer S for stabilization of an aqueous composition comprising at least one acrylamide polymer P. The above-described embodiments of the acrylamide polymer P, of the stabilizer S and of the optional further additives in the aqueous composition apply correspondingly to the use of the stabilizer S. More particularly, the invention relates to the use of the above-described stabilizer S for stabilization of an aqueous composition comprising at least one acrylamide polymer P against heat, light and oxygen.

More particularly, it is possible through the use of the above-described stabilizer S to entirely or partly dispense with the exclusion of oxygen, meaning that it is possible to achieve good stabilization of the acrylamide polymer solution in the presence of oxygen too. Thus, it is unnecessary, for example, to treat (inertize) the aqueous composition with an inert gas, for example nitrogen N₂, prior to use in mineral oil production (e.g. polymer flooding) and/or to add an oxygen scavenger. In a preferred embodiment, the invention relates to the use of an above-described stabilizer S for stabilization of an aqueous composition comprising at least one acrylamide polymer P in the presence of oxygen.

In a further aspect, the invention relates to a process for mineral oil production (especially for tertiary mineral oil production), in which an aqueous formulation comprising at least one acrylamide polymer P and at least one stabilizer S of the formula (I)

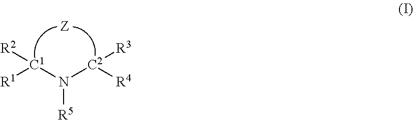

where the radicals are each defined as follows:
Z is a bivalent group comprising 2 to 5 atoms and/or groups selected from C(R⁶)₂, O, S, N—R′ and C═O, where the Z group together with the carbon atoms C¹, C² and the nitrogen atom N forms a 5- to 8-membered ring, where R′ is selected from H, C₁₋₂₀-alkyl, C₂₋₂₀-alkenyl, C₆₋₂₀-aryl, C₇₋₃₂-arylalkyl, C₁₋₂₀-hydroxyalkyl, C₁₋₂₀-aminoalkyl, C₁₋₂₀-cyanoalkyl, C₁₋₂₀-haloalkyl, C₁₋₂₀-sulfoalkyl and C₁₋₂₀-phosphonoalkyl;
   where R⁶ is independently selected from H; OH; CN; C₁₋₂₀-alkyl; C₂₋₂₀-alkenyl; C₂₋₂₀-alkynyl; C₆₋₂₀-aryl; C₇₋₃₂-arylalkyl; C₁₋₂₀-alkoxy; C₁₋₂₀-hydroxyalkyl; C₁₋₂₀-aminoalkyl; C₁₋₂₀-cyanoalkyl; C₁₋₂₀-haloalkyl; halogen; C₁₋₂₀-sulfoalkyl; C₁₋₂₀-phosphonoalkyl; —(CH₂—CH(R^{a})—O)_{q}—H with q=1-20 and R^{a}=H or C₁₋₆-alkyl; —O—C(═O)R^{b} with R^{b}=H. C₁₋₂₀-alkyl, C₂₋₂₀-alkenyl, C₂₋₂₀-alkynyl, C₆₋₂₀-aryl or C₇₋₃₂-arylalkyl; —O—C(═O)—(CH₂)ₘ—C(═O)—O—R^{c}; —O—C(═O)—Y—C(═O)—O—R^{c}, where m=1-10, R^{c}=H, C₁₋₂₀-alkyl, C₂₋₂₀-alkenyl, C₂₋₂₀-alkynyl, C₆₋₂₀-aryl, C₇₋₃₂-arylalkyl or 1,2,2,6,6-pentamethylpiperidin-4-yl and Y is a C₂₋₁₀-alkenylene group; —O—R^{d} with R^{d}=C₂₋₂₀-alkenyl, C₂₋₂₀-alkynyl, C₆₋₂₀-aryl, C₇₋₃₂-arylalkyl or 1,2,2,6,6-pentamethylpiperidin-4-yl; —NR^{x}R^{y}, —N(R^{x})—C(═O)R^{y}; —N(R^{x})—C(═O)—Y—C(═O)—O—R^{y}; —N(R^{x})—(CH₂)ᵣ—NR^{y}R^{z} where R^{x}, R^{y} and R^{z} are each independently H, C₁₋₂₀-alkyl, C₂₋₂₀-alkenyl, C₂₋₂₀-alkynyl, C₆₋₂₀-aryl, C₇₋₃₂-arylalkyl, C₁₋₂₀-hydroxyalkyl, C₁₋₂₀-aminoalkyl or 1,2,2,6,6-pentamethylpiperidin-4-yl, r=1-10 and Y is a C₂₋₁₀-alkenylene group; —(O—CH₂—CH(R^{e})—(CH₂)ᵢ)ₚ—O—R^{e′} with p=1-20, i=0 or 1, R^{e}=H, OH or C₁₋₆-alkyl and R^{e′}=H or C₁₋₈-alkyl; —S—R¹; —S—S—R^{f} with R^{f}=H, C₁₋₂₀-alkyl, C₂₋₂₀-alkenyl, C₆₋₂₀-aryl or C₇₋₃₂-arylalkyl;
   or where two R⁶ radicals together with the carbon atom to which they are bonded form a —C—(O—CH₂—CH₂—O)—, —C—(O—CH₂—CH₂—CH₂—O)—, —C—(O—C(CH₃)₂—C(CH₃)₂—O)— or —C—(NH—C(═O)—NH—C(═O))— ring;
R¹, R², R³ and R⁴
   are each independently selected from C₁₋₂₀-alkyl, C₂₋₂₀-alkenyl, C₆₋₂₀-aryl, C₇₋₃₂-arylalkyl, C₁₋₂₀-alkoxy, C₁₋₂₀-hydroxyalkyl, C₁₋₂₀-aminoalkyl or C₁₋₂₀-haloalkyl;
   or the R¹ and R² radicals together with C¹ or the R³ and R⁴ radicals together with C² form a ring which comprises 5 to 7 carbon atoms and which may optionally be substituted by one or more R⁶ groups;
R⁵ is H; C₁₋₂₀-alkyl; C₂₋₂₀-alkenyl; C₂₋₂₀-alkynyl; C₆₋₂₀-aryl; C₇₋₃₂-arylalkyl; C₁₋₂₀-alkoxy; C₄₋₈-cycloalkoxy; C₁₋₂₀-hydroxyalkyl; C₁₋₂₀-aminoalkyl; C₁₋₂₀-cyanoalkyl; haloalkyl; C₁₋₂₀-sulfoalkyl; C₁₋₂₀-phosphonoalkyl; —(CH₂—CH(R^{a})—O)_{q}—H with q=1-20 and R^{a}=H or C₁₋₆-alkyl; —O—C(═O)R^{b} with R^{b}=H, C₁₋₂₀-alkyl, C₂₋₂₀-alkenyl, C₂₋₂₀-alkynyl, C₆₋₂₀-aryl or C₇₋₃₂-arylalkyl; —O—C(═O)—(CH₂)ₘ—C(═O)—O—R^{c}; —O—C(═O)—Y—C(═O)—O—R^{c}, where m=1-10, R^{c}=H, C₁₋₂₀-alkyl, C₂₋₂₀-alkenyl, C₂₋₂₀-alkynyl, C₆₋₂₀-aryl, C₇₋₃₂-arylalkyl or 1,2,2,6,6-pentamethylpiperidin-4-yl and Y is a C₂₋₁₀-alkenylene group; —O—R^{d} with R^{d}=C₂₋₂₀-alkenyl, C₂₋₂₀-alkynyl, C₆₋₂₀-aryl, C₇₋₃₂-arylalkyl or 1,2,2,6,6-pentamethylpiperidin-4-yl; —(O—CH₂—CH(R^{e})—(CH₂)ᵢ)ₚ—O—R^{e′} with p=1-20, i=0 or 1, R^{e}=H, OH or C₁₋₆-alkyl and R^{e′}=H or C₁₋₈-alkyl; —C(═O)—R^{h} with R^{h}=H, C₁₋₂₀-alkyl, C₂₋₂₀-alkenyl, C₆₋₂₀-aryl or C₇₋₂₀-arylalkyl; 2,2,6,6-tetramethyl-4-piperidinol-1-yl-alkyl or 4-(2,2,6,6-tetramethyl-4-piperidinol-1-ylalkyl)benzyl;
   is injected into an underground formation through at least one injection well and crude oil is withdrawn from the underground formation through at least one production well.

For the process according to the invention for mineral oil production, the embodiment relating to the acrylamide polymer P and the stabilizer S and optionally further additives described above in connection with the composition apply correspondingly.

In the context of the present invention, “underground formation” refers to an underground rock formation comprising a deposit comprising crude oil.

More particularly, the invention relates to a process for mineral oil production as described above, wherein the at least one acrylamide polymer P is a copolymer comprising (meth)acrylamide and at least one anionic, monoethylenically unsaturated, hydrophilic monomer (b) comprising at least one acidic group selected from the group of —COOH, —SO₃H and —PO₃H₂ or salts thereof.

More particularly, it is possible in the process according to the invention for mineral oil production using the stabilizer S to entirely or partly dispense with the exclusion of oxygen, meaning it is possible to achieve good stabilization of the acrylamide polymer solution in the presence of oxygen too. Thus, in the process according to the invention for mineral oil production, more particularly, there is no need for the process step relating to the treatment of the aqueous composition with an inert gas (inertization) and/or it is possible to very substantially dispense with the use of oxygen scavengers in the process according to the invention.

Preferably, the present invention relates to an above-described process for mineral oil production, wherein the process is performed in the presence of oxygen (or without a process step for exclusion of oxygen and/or without the addition of oxygen scavengers). One advantage of the process according to the invention for mineral oil production is thus that there is no need for a complex process step (inertization) or the use of additional additives (oxygen scavengers).

More particularly, the process for mineral oil production is a so-called polymer flooding process. Polymer flooding is typically accomplished by injecting an aqueous, viscous polymer formulation into a well which projects into a mineral oil deposit (mineral oil formation). This well is typically also called injection well and is generally lined with cement-secured steel tubes; in the region of the mineral oil formation, these tubes are perforated and thus allow the polymer formulation to leave the injection well and enter the mineral oil deposit. Typically, crude oil is withdrawn from the deposit through a further well, called the production well.

More particularly, the invention relates to a process for mineral oil production as described above, wherein the underground formation has a temperature of 30 to 180° C., especially of 80 to 150° C. More particularly, the invention relates to a process for mineral oil production as described above, wherein the underground formation has an average porosity of 10 millidarcies to 4 darcies.

To increase the mineral oil yield, polymer flooding can advantageously be combined with other techniques for tertiary mineral oil production. In a preferred embodiment of the invention, polymer flooding using the above-described inventive compositions can be combined with a preceding surfactant flooding operation. In this case, especially prior to the polymer flooding, an aqueous surfactant formulation can first be injected into the mineral oil formation, which reduces the interfacial tension between the formation water and the mineral oil and hence increases the mobility of the mineral oil in the formation. The combination of the two techniques can often increase the mineral oil yield. Examples of suitable surfactants for surfactant flooding include surfactants having sulfate groups, sulfonate groups, polyoxyalkylene groups, anionically modified polyoxyalkylene groups, betaine groups, glucoside groups or amine oxide groups, for example alkylbenzenesulfonates, olefinsulfonates or amidopropyl betaines. It may be preferable to use anionic and/or betaine surfactants.

The person skilled in the art is aware of details of the industrial performance of “polymer flooding” and “surfactant flooding”, and will employ an appropriate technique according to the type of deposit, it will be appreciated that it is also possible to use the abovementioned surfactants directly in the inventive compositions.

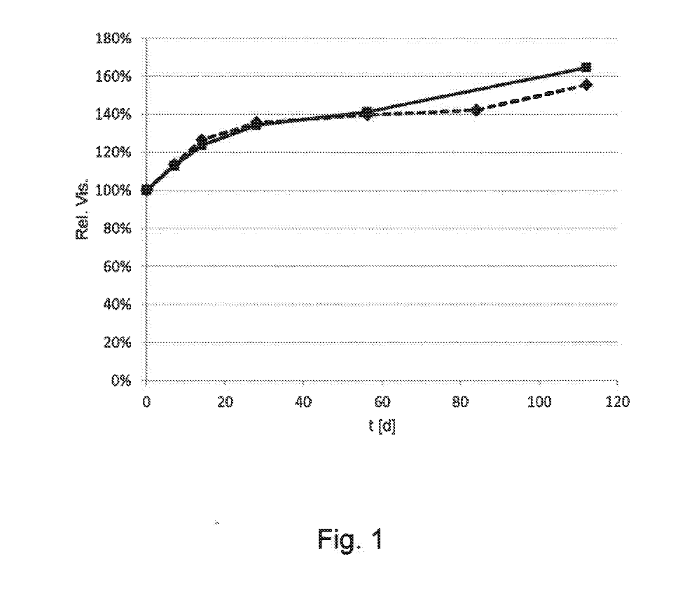

FIG. 1 describes the long-term thermal stability of the inventive compositions, which has been determined as described in example 4. The filled squares (▪) show the relative viscosity (Rel. vis.) of an aqueous solution of an acrylamide polymer which has been prepared by means of addition of the stabilizer PMP prior to the polymerization (experiment 3.5 according to example 3), as a function of storage time at 80° C. in days (d). The filled rhombuses (♦) show the relative viscosity (Rel. vis.) of a polymer solution which has been obtained by mixing PMP and an independently produced acrylamide polymer, as a function of storage time at 80° C. in days (d).

The present invention is illustrated in detail by the examples which follow.

### EXAMPLES

### Example 1

### Preparation and Testing of the Compositions with PMP

An aqueous solution of 1000 ppm of an acrylic acid/acrylamide copolymer (Aspiro® P 4201 from BASF, acrylamide/acrylic acid copolymer, anionicity 20-30%, M_{w} ˜15-20 million g/mol) in tapwater was admixed with the appropriate combination of free-radical scavenger and sacrificial reagent. Subsequently, the solution was transferred to a test tube. The test tube was then sealed by fusion. The samples were stored in an oven at 80° C. for one to six weeks.

The inventive stabilizer S used was 1,2,2,6-pentamethyl-4-piperidinol (PMP). As comparative examples, compositions comprising the known stabilizers sodium 2-mercaptobenzothiazole (NaMBT) and sodium thiocyanate (NaSCN) were used. The use concentrations are compiled in table 1. The sacrificial reagent used in experiments 3 to 7 was 2-propanol in an amount of 200 ppm.

In experiments 1 and 3 to 7, the composition was not inertized, nor was an oxygen scavenger added. Only in experiment 2 was the polymer solution inertized with nitrogen N₂ for comparative purposes prior to storage.

Table 1 below shows the viscosity values of the polymer solutions in mPas (measured with a Brookfield LV with UL adapter at 6 rpm, 25° C.) after the appropriate storage periods. In each case, 3 tests were conducted under the same conditions; the values obtained were averaged. The results are summarized in the following table 1.

TABLE 1
Compositions and viscosity values [in mPas] after storage - PMP

| | Experiment no. | | | | | | |
|---|---|---|---|---|---|---|---|
| | | 2 | | | | | |
| | 1 | Comparative | 3 | 4 | 5 | 6 | |
| | Comparative | experiment | Comparative | Comparative | Comparative | Comparative | |
| Composition | experiment | inertized | experiment | experiment | experiment | experiment | 7 |
| NaMBT [ppm] | — | — | 20 | 50 | 100 | — | — |
| NaSCN [ppm] | — | — | — | — | — | 50 | — |
| PMP [ppm] | — | — | — | — | — | — | 50 |
| 2-propanol [ppm] | — | — | 200 | 200 | 200 | 200 | 200 |

| Storage time | Viscosity | Viscosity | Viscosity | Viscosity | Viscosity | Viscosity | Viscosity |
|---|---|---|---|---|---|---|---|
| in weeks | [mPas] | [mPas] | [mPas] | [mPas] | [mPas] | [mPas] | [mPas] |
| 0 (starting | 30.3 | 28.6 | 30.8 | 30.7 | 30.7 | 30.9 | 30.1 |
| value) | | | | | | | |
| 1 | 15.1 | 32.3 | 33.2 | — | — | 30.3 | 35.1 |
| 2 | 10.3 | 25.6 | 33.7 | 11.4 | 11.8 | 30.2 | 36 |
| 4 | 11.3 | 22.1 | 4.9 | 7.3 | 8.1 | 11.4 | 38.1 |
| 6 | 5.1 | 13.7 | — | 5.0 | 5.3 | — | — |

Comparative experiment 1, in which no stabilizers at all were used, shows that the viscosity of the polymer solutions decreases considerably with increasing storage time at 80° C. The decline in viscosity can be reduced by inertization (see comparative experiment 2).

The mercaptobenzothiazole (MBT) and NaSCN stabilizers known from the prior art do show a certain degree of slowing in the case of short storage times, but the viscosity after 6 weeks is similarly low to that without stabilizer. Interestingly, no improvement in the stabilizing action is possible in the case of the known MBT stabilizer even through an increase in concentration.

In experiment 7 using the inventive stabilizer S, the viscosity does not decrease within the test period. The slight increase in the viscosity can be explained by the commencement of hydrolysis of acrylamide units to acrylic acid units.

### Example 2

### Production and Testing of Further Compositions

Analogously to example 1, aqueous solutions of an acrylic acidiacrylamide copolymer were prepared with the following inventive stabilizers S (V4, V8, V9, V11, V13), each at a dosage of 50 ppm:

| | | |
|---|---|---|
| V4 | 1-ethyl-2,2,6,6-tetramethyl-4-piperidinol | 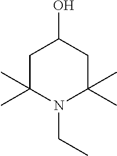 |
| V8 | 1-acetyl-2,2,6,6-tetramethyl-4-piperidinol | 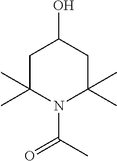 |
| V9 | 1-(2-hydroxypropyl)-2,2,6,6-tetramethyl- 4-piperidinol | 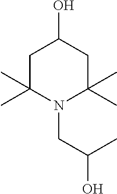 |
| V11 | 1-allyl-2,2,6,6-tetramethyl-4-piperidinol | 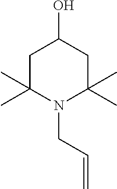 |
| V13 | 1-(2-hydroxybutyl)-2,2,6,6-tetramethyl- 4-piperidinol | 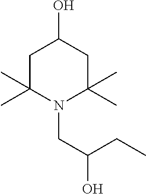 [SMILES: CCC(O)CN1C(C)(C)CC(O)CC1(C)C] |

The stability of aqueous polymer solutions was examined as described in example 1 by means of viscosity measurements. The results are compiled in table 2 below.

TABLE 2
Compositions and viscosity values [in mPas] after storage

| | Experiment no. | | | | |
|---|---|---|---|---|---|
| | 8 | 9 | 10 | 11 | 12 |
| Stabilizer | V4 | V11 | V13 | V8 | V9 |
| Storage time in | Viscosity | Viscosity | Viscosity | Viscosity | Viscosity |
| weeks | [mPas] | [mPas] | [mPas] | [mPas] | [mPas] |
| 0 starting value | 32.3 | 32.4 | 32.6 | 30.4 | 30.6 |
| 1 | 36.45 | 35.8 | 35.7 | 33.8 | 37.15 |
| 2 | 36.6 | 37.55 | 37.1 | 34.3 | 35.4 |
| 4 | 36.7 | 37.75 | 37.65 | 34.75 | 35.2 |
| 6 | 35.4 | 37.15 | 35.65 | 33.9 | 30.65 |

### Example 3

### 3.1 Preparation of Acrylamide Copolymers with Addition of Stabilizer S

In the example which follows, acrylamide copolymers comprising acrylamide and sodium acrylate (monomer b2) were prepared with addition of hydroxypentamethylpiperidine (PMP) as stabilizer S, with addition of various amounts of hydroxypentamethylpiperidine (PMP) in the range from 0 to 1% by weight, based on the total amount of the monomers. Each polymerization was effected by means of adiabatic gel polymerization. The copolymers were characterized as described in example 3.2.

The experimental procedure is described in detail hereinafter for the addition of 1% by weight of hydroxypentamethylpiperidine:

A plastic bucket with a magnetic stirrer, pH meter and thermometer was initially charged with 112.8 g of a 35% solution of sodium acrylate, and then the following were added successively: 108.33 g of distilled water, 163.99 g of acrylamide (49.1% solution), 1.2 g of Trilon C (5% solution), 1.3 g of hydroxypentamethylpiperidine and 4 ml of a 4% solution of 4,4′-azobis(4-cyanovaleric acid) (ACVA).

After setting the pH to a value of 6.5 with 20% or 2% sulfuric acid and adding the rest of the water (total amount of water minus the amount of water already added, minus the amount of acid required), the monomer solution was adjusted to the starting temperature of 0° C. The solution was transferred to a thermos flask and a temperature sensor for the temperature recording was attached. The solution was purged with nitrogen for 30 minutes and then admixed with 1 ml of a 4% azobis(isobutyronitrile) (AIBN) solution in methanol, 0.1 ml of a 1% tert-butyl hydroperoxide (t-BHP) solution and 0.2 ml of a 1% sodium sulfite solution, in order to start the polymerization.

A gel block was obtained, which was comminuted with the aid of a meat grinder. The gel granules obtained were dried in a fluidized bed dryer at 55° C. for two hours. This gave a white, hard granular material, which was converted to a pulverulent state by means of a centrifugal mill.

### 3.2 Characterization of the Acrylamide Copolymers

The acrylamide copolymers obtained under 3.1 were characterized as described below. The results are compiled in table 3 below.

i) The viscosity of solutions of the acrylamide copolymer in tap water having a polymer concentration of 1000 ppm was measured at 25° C. This was done using a shear rate of 7 s⁻¹ in a Brookfield LV-DV II with a UL adapter or a Haake RS 80 or Anton Paar MCR 301 rheometer (both rheometers with double-gap geometry).
ii) In addition, the filterability was studied with the aid of the MPFR value (Millipore filtration ratio). The MPFR value (Millipore filtration ratio) indicates the deviation of a polymer solution from ideal filtration characteristics, with no reduction in the filtration rate as a result of blockage of the filter in the case of ideal filtration characteristics.

To determine the MPFR values, about 200 ml of polymer solution having a concentration of 1000 ppm were filtered at a pressure of 20 psi through a polycarbonate filter having a pore size of 5 μm. In the course of this, the amount of filtrate was recorded as a function of time. The MPFR value was calculated by the following formula:

MPFR=(t_{180 g}−t_{160 g})/(t_{80 g}−t_{60 g})

with t_{index}=time at which the given amount of filtrate was measured, i.e. t_{180 g} is the time at which 180 g of filtrate were measured. According to API RP 63 (“Recommended Practices for Evaluation of Polymers Used in Enhanced Oil Recovery Operations”, American Petroleum Institute), values less than 1.3 are acceptable.
iii) The gel content of the acrylamide copolymers obtained in 3.1 was determined by sieving 1 l of a polymer solution having a concentration of 1000 ppm through a 200 μm sieve and determining the gel content remaining on the sieve,

TABLE 3
Characterization of the acrylamide copolymers

| | Amount | | | Gel |
|---|---|---|---|---|
| Experiment | of PMP | Viscosity | | content |
| No. | [% by wt.] | [mPas] | MPFR | [ml] |
| 3.1 | 0% | 30 mPas | 1.28 | 1-2 |
| 3.2 | 1% | 30 mPas | 1.10 | 1 |
| 3.3 | 0.75% | 31 mPas | 1.16 | 1 |
| 3.4 | 0.5% | 32 mPas | 1.11 | <1 |
| 3.5 | 0.35% | 36 mPas | 1.07 | — |

Experiment 3.1 is a comparative example in which no stabilizer S (hydroxypentamethyl-piperidine (PMP)) was added. The amount of PMP in % by weight is based in each case on the total amount of the monomers.

As a result of the addition of 0.35% by weight of stabilizer in the polymerization, a distinct increase in the viscosity of the acrylamide copolymer was observed. In the case of higher added amounts of stabilizer S, the viscosity of the acrylamide copolymers obtained remained about the same as the viscosity without addition of the stabilizer S.

Both the MPFR test and the measurement of the gel content show that the insoluble gel fractions in the acrylamide copolymer can be reduced considerably when the stabilizer S has already been added prior to the polymerization to give the monomer solution. This variant thus led to a distinct improvement in the properties of the acrylamide copolymer with regard to the use thereof in tertiary mineral oil production.

### Example 4

### Studies of Long-Term Thermal Stability

The long-term thermal stability of the acrylamide copolymer from experiment no. 3.5 was evaluated in comparison to a mixture of PMP stabilizer and acrylic acid/acrylamide copolymer, with mixing of the two components after the preparation of the copolymer.

An aqueous copolymer solution having a polymer concentration of 1000 ppm was prepared using the acrylamide copolymer from experiment 3.5 (example 3.1 and table 3). In addition, an aqueous copolymer solution having a polymer concentration of 1000 ppm was prepared using the acrylic acid/acrylamide copolymer according to example 1 with addition of an appropriate amount of PMP. Thereafter, the aqueous solution of the copolymer/stabilizer mixture was inertized by purging with N₂ for 30 minutes and adding 50 ppm of Na₂SO₃ as oxygen scavenger.

Subsequently, the solutions were transferred to a plurality of test tubes. The test tubes were subsequently sealed by fusion. The samples were stored in an oven at 80° C. for 1 to 16 weeks. At regular intervals, test tubes were removed and the viscosity was measured by means of a Brookfield LV with a UL adapter at 6 rpm and 25° C. 2 tests were conducted under the same conditions in each case; the values obtained were averaged.

The results are shown in FIG. 1. FIG. 1 shows the relative viscosity (Rel. vis.) of the polymer solution in % (y axis) as a function of storage time at 80° C. in days d (x axis). The relative viscosity indicates the viscosity of the polymer solution at time t in relation to the viscosity at time t=0:

Rel. vis. [%]=(viscosity at time t/viscosity at time t=0)*100.

As can be seen in FIG. 1, the long-term thermal stability of the acrylamide copolymer from experiment 3.5 (filled squares ▪), which has been prepared by means of addition of the PMP stabilizer prior to the polymerization, is just as good as that of the mixture of PMP and the independently produced copolymer (filled rhombuses ♦).

1.-18. (canceled)

19. A composition comprising at least one acrylamide polymer, which comprises at least 10% by weight of (meth)acrylamide, based on the total amount of all the monomers in the acrylamide polymer, and at least one stabilizer of formula (I) 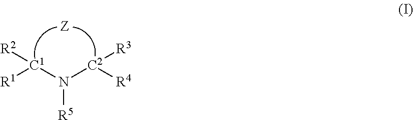
where:
Z is a bivalent group that optionally includes groups selected from C(R⁶)₂, O, S, N—R′ or C═O, where the Z group together with the carbon atoms C¹, C² and the nitrogen atom N forms a 5- to 8-membered ring, where R′ is selected from H, C₁₋₂₀-alkyl, C₂₋₂₀-alkenyl, C₆₋₂₀-aryl, C₇₋₃₂-arylalkyl, C₁₋₂₀-hydroxyalkyl, C₁₋₂₀-aminoalkyl, C₁₋₂₀-cyanoalkyl, C₁₋₂₀-haloalkyl, C₁₋₂₀-sulfoalkyl, or C₁₋₂₀-phosphonoalkyl;
where R⁶ is independently selected from: H; OH; CN; C₁₋₂₀-alkyl; C₂₋₂₀-alkenyl; C₂₋₂₀-alkynyl; C₆₋₂₀-aryl; C₇₋₃₂-arylalkyl; C₁₋₂₀-alkoxy; C₁₋₂₀-hydroxyalkyl; C₁₋₂₀-aminoalkyl; C₁₋₂₀-cyanoalkyl; C₁₋₂₀-haloalkyl; halogen; C₁₋₂₀-sulfoalkyl; C₁₋₂₀-phosphonoalkyl; —(CH₂—CH(R^{a})—O)_{q}—H with q=1-20 and R^{a}=H or C₁₋₆-alkyl; —O—C(═O)R^{b} with R^{b}=H, C₁₋₂₀-alkyl, C₂₋₂₀-alkenyl, C₂₋₂₀-alkynyl, C₆₋₂₀-aryl or C₇₋₃₂-arylalkyl; —O—C(═O)—(CH₂)ₘ—C(═O)—O—R^{c}; —O—C(═O)—Y—C(═O)—O—R^{c}, where m=1-10, R^{a}=H, C₁₋₂₀-alkyl, C₂₋₂₀-alkenyl, C₂₋₂₀-alkynyl, C₆₋₂₀-aryl, C₇₋₃₂-arylalkyl or 1,2,2,6,6-pentamethylpiperidin-4-yl and Y is a C₂₄₀-alkenylene group; —O—R^{d} with R^{d}=C₂₋₂₀-alkenyl, C₂₋₂₀-alkynyl, C₆₋₂₀-aryl, C₇₋₃₂-arylalkyl or 1,2,2,6,6-pentamethylpiperidin-4-yl; —NR^{x}R^{y}; —N(R^{x})—C(═O)R^{y}; —N(R^{x})—C(═O)—Y—C(═O)—O—R^{y}; —N(R^{x})—(CH₂)ᵣ—NR^{y}R^{z} where R^{x}, R^{y} and R^{z} are each independently H, C₁₋₂₀-alkyl, C₂₋₂₀-alkenyl, C₂₋₂₀-alkynyl, C₆₋₂₀-aryl, C₇₋₃₂-arylalkyl, C₁₋₂₀-hydroxyalkyl, C₁₋₂₀-aminoalkyl or 1,2,2,6,6-pentamethylpiperidin-4-yl, r=1-10 and Y is a C₂₋₁₀-alkenylene group; —(O—CH₂—CH(R^{e})—(CH₂)ᵢ)ₚ—O—R^{e′} with p=1-20, i=0 or 1, R^{e}=H, OH or C₁₋₆-alkyl, and R^{e′}=H or C₁₋₁₈-alkyl; —S—R^{f}; —S—S—R^{f} with R^{f}=H, C₁₋₂₀-alkyl, C₂₋₂₀-alkenyl, C₆₋₂₀-aryl or C₇₋₃₂-arylalkyl;
or where two R⁶ radicals together with the carbon atom to which they are bonded form a —C—(O—CH₂—CH₂—O)—, —C—(O—CH₂—CH₂—CH₂—O), —C—(O—C(CH₃)₂—C(CH₃)₂—O)— or —C—(NH—C(═O)—NH—C(═O))— ring;
R¹, R², R³ and R⁴
are each independently selected from C₁₋₂₀-alkyl, C₂₋₂₀-alkenyl, C₆₋₂₀-aryl, C₇₋₃₂-arylalkyl, C₁₋₂₀-alkoxy, C₁₋₂₀-hydroxyalkyl, C₁₋₂₀-aminoalkyl or C₁₋₂₀-haloalkyl;
or the R¹ and R² radicals together with C¹, or the R³ and R⁴ radicals together with C², form a ring which comprises 5 to 7 carbon atoms and which may optionally be substituted by one or more R⁶ groups;
R⁵ is H; C₁₋₂₀-alkyl; C₂₋₂₀-alkenyl; C₂₋₂₀-alkynyl; C₆₋₂₀-aryl; C₇₋₃₂-arylalkyl; C₁₋₂₀-alkoxy; C₄₋₈-cycloalkoxy; C₁₋₂₀-hydroxyalkyl; C₁₋₂₀-aminoalkyl; C₁₋₂₀-cyanoalkyl; C₁₋₂₀-haloalkyl; C₁₋₂₀-sulfoalkyl; C₁₋₂₀-phosphonoalkyl; —(CH₂—CH(R^{a})—O)_{q}—H with q=1-20 and R^{a}=H or C₁₋₆-alkyl; —O—C(═O)R^{b} with R^{b}=H, C₁₋₂₀-alkyl, C₂₋₂₀-alkenyl, C₂₋₂₀-alkynyl, C₆₋₂₀-aryl or C₇₋₃₂-arylalkyl; —O—C(═O)—(CH₂)ₘ—C(═O)—O—R^{c}; —O—C(═O)—Y—C(═O)—O—R^{c}, where m=1-10, R^{c}=H, C₁₋₂₀-alkyl, C₂₋₂₀-alkenyl, C₂₋₂₀-alkynyl, C₆₋₂₀-aryl, C₇₋₃₂-arylalkyl or 1,2,2,6,6-pentamethylpiperidin-4-yl and Y is a C₂₋₁₀-alkenylene group; —O—R^{d} with R^{d}=C₂₋₂₀-alkenyl, C₂₋₂₀-alkynyl, C₆₋₂₀-aryl, C₇₋₃₂-arylalkyl or 1,2,2,6,6-pentamethylpiperidin-4-yl; —(O—CH₂—CH(R^{e})—(CH₂)ᵢ)ₚ—O—R^{e′} with p=1-20, i=0 or 1, R^{e}=H, OH or C₁₋₆-alkyl and R^{e′}=H or C₁₋₈-alkyl; —C(═O)—R^{h} with R^{h}=1-1, C₁₋₂₀-alkyl, C₂₋₂₀-alkenyl, C₆₋₂₀-aryl or C₇₋₂₀-arylalkyl; 2,2,6,6-tetramethyl-4-piperidinol-1-yl-alkyl or 4-(2,2,6,6-tetramethyl-4-piperidinol-1-ylalkyl)benzyl.

20. The composition according to claim 19, wherein the at least one acrylamide polymer P is a copolymer comprising (meth)acrylamide and at least one anionic, monoethylenically unsaturated, hydrophilic monomer (b) comprising at least one acidic group selected from the group of —COOH, —SO₃H and —PO₃H₂ or salts thereof.

21. The composition according to claim 19, wherein the at least one acrylamide polymer is a copolymer comprising (meth)acrylamide and at least one monoethylenically unsaturated, hydrophobically associating monomer (a), where the monomer (a) has the following structure (IP):
H₂C═C(R^{1P})—R^{2P}—O-(—CH₂—CH(R^{3P})—O—)ₖ-(—CH₂—CH(R^{4P})—O—)ₗ-R^{5P} (IP)
where
R^{1P} is H or a methyl group;
R^{2P} is a single bond or a divalent linking group selected from the group consisting of —(CₙH₂ₙ)—, —O—(C_{n′}H_{2n′})— and C(O)—O—(C_{n″}H_{2n″})—, where n is a natural number from 1 to 6 and n′ and n″ are each a natural number from 2 to 6;
R^{3P} is independently H, methyl or ethyl;
R^{4P} is independently a hydrocarbyl radical of at least 2 carbon atoms;
R^{5P} is H or a hydrocarbyl radical having 1 to 30 carbon atoms;
k is an integer from 10 to 150; and
l is an integer from 5 to 25.

22. The composition according to claim 19, wherein the at least one acrylamide polymer is a copolymer comprising (meth)acrylamide and at least one cationic monomer of the structure (KI): 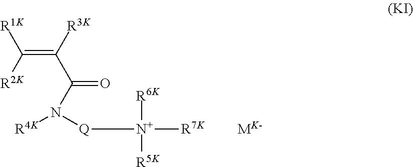
where
R^{1K}, R^{2K}, R^{3K}, R^{4K}, R^{5K}, R^{6K}
are each independently H or C₁₋₄ alkyl;
Q is C₁₋₈-alkylene;
R^{7K} is a C₈₋₃₀ alkyl or C₈₋₃₀-arylalkyl;
M^{K} is a halogen selected from bromine, chlorine, iodine, fluorine and a negatively charged counterion.

23. The composition according to claim 19, wherein the at least one stabilizer of formula (I) is present, where:
Z is a bivalent group comprising 2 to 5 groups selected from C(R⁶)₂, N—R′ and C═O, where the Z group together with the carbon atoms C¹, C² and the nitrogen atom N forms a 5- to 8-membered ring, where R′ is selected from H, C₁₋₁₈-alkyl and C₁₋₁₈-hydroxyalkyl;
where R⁶ is selected from H; OH; CN; C₁₋₂₀-alkyl; C₁₋₂₀-hydroxyalkyl; —O—C(═O)R^{b} with R^{b}=H, C₁₋₂₀-alkyl, C₂₋₂₀-alkenyl, C₂₋₂₀-alkynyl, C₆₋₂₀-aryl or C₇₋₃₂-arylalkyl; —O—C(═O)—(CH₂)ₘ—C(═O)—O—R^{e}, where m=1-10, R^{c}H, C₁₋₂₀-alkyl, C₂₋₂₀-alkenyl, C₂₋₂₀-alkynyl, C₆₋₂₀-aryl, C₇₋₃₂-arylalkyl or 1,2,2,6,6-pentamethylpiperidin-4-yl; —O—R^{d} with R^{d}=C₂₋₂₀-alkenyl, C₂₋₂₀-alkynyl, C₆₋₂₀-aryl, C₇₋₃₂-arylalkyl or 1,2,2,6,6-pentamethylpiperidin-4-yl; —NR^{x}R^{y}, where R^{x} and R^{y} are each independently H, C₁₋₂₀-alkyl, C₂₋₂₀-alkenyl, C₆₋₂₀-aryl, C₇₋₃₂-arylalkyl, C₁₋₂₀-hydroxyalkyl or C₁₋₂₀-aminoalkyl;
or where two R⁶ radicals together with the carbon atom to which they are bonded form a —C—(O—CH₂—CH₂—O)—, —C—(O—CH₂—CH₂—CH₂—O)—, —C—(O—C(CH₃)₂—C(CH₃)₂—O)— or C—(NH—C(═O)—NH—C(═O))— ring;
R¹, R², R³ and R⁴
are each independently selected from C₁₋₂₀-alkyl, C₂₋₂₀-alkenyl and C₇₋₃₂-arylalkyl;
R⁵ is H; C₁₋₂₀-alkyl; C₂₋₂₀-alkenyl; C₇₋₃₂-arylalkyl; C₁₋₂₀-hydroxyalkyl; C₁₋₂₀-cyanoalkyl; C₁₋₂₀-sulfoalkyl; C₁₋₂₀-phosphonoalkyl; —(CH₂—CH(R^{a})—O)ₘ—H with m=1-20 and R^{a}=H or C₁₋₆-alkyl; —C(═O)—R^{h} with R^{h}=H, C₁₋₂₀-alkyl, C₂₋₂₀-alkenyl, C₆₋₂₀-aryl or C₇₋₂₀-arylalkyl; 2,2,6,6-tetramethyl-4-piperidinol-1-ylalkyl or 4-(2,2,6,6-tetramethyl-4-piperidinol-1-ylalkyl)benzyl.

24. The composition according to claim 19, wherein the at least one stabilizer is selected from compounds of formulae (II) to (IV) 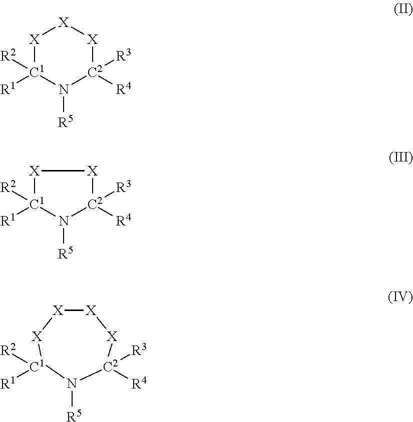
where X is independently a group selected from C(R⁶)₂, N—R′ and C═O, and where the R¹, R², R³, R⁴, R⁵, R⁶ and R′ radicals are each as defined in claim 19.

25. The composition according to claim 19, wherein the at least one stabilizer is selected from compounds of the formulae (X1) to (X5) 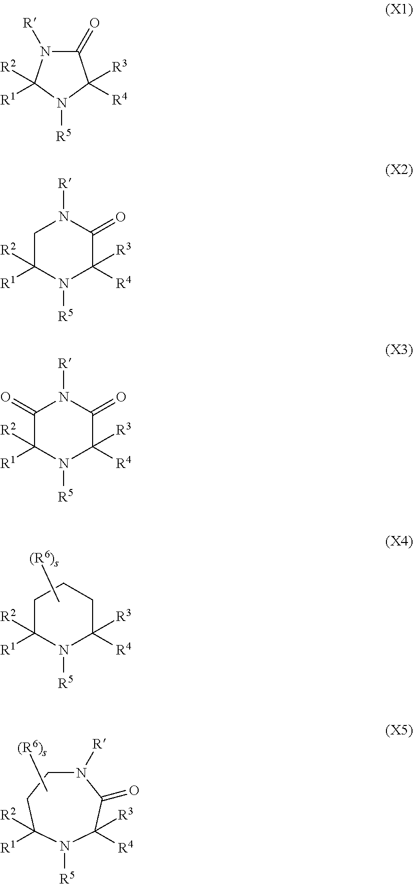
where the R¹, R², R³, R⁴, R⁵, R⁶ and R′ are each as defined in claim 19 and s is an integer from 0 to 6.

26. The composition according to claim 19, wherein the at least one stabilizer is selected from compounds of formulae (VI) 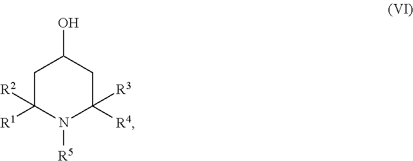
where the R¹, R², R³, R⁴ and R⁵ radicals are each as defined in claim 19.

27. The composition according to claim 19, being an aqueous composition comprising 0.01 to 10% by weight of the at least one acrylamide polymer, and 1 to 1000 ppm of the at least one stabilizer.

28. A process for producing a composition according to claim 19, comprising adding the at least one stabilizer to a monomer mixture prior to polymerization of the at least one acrylamide polymer, or adding the at least one stabilizer to a monomer mixture during polymerization of the at least one acrylamide polymer, wherein the at least one acrylamide polymer comprises at least 10% by weight of (meth)acrylamide, based on the total amount of all the monomers in acrylamide polymer, and the at least one stabilizer.

29. The production process according to claim 28, further comprising at least one of the following steps:
mixing the at least one stabilizer with a solid acrylamide polymer;
extruding a mixture of a solid acrylamide polymer and the at least one stabilizer;
applying a solution of the at least one stabilizer in a solvent to a solid acrylamide polymer;
applying a solution of the at least one stabilizer in a solvent to an acrylamide polymer gel;
adding the at least one stabilizer during the drying of an acrylamide polymer gel; or
adding the at least one stabilizer before or during the polymerization of the acrylamide polymer.

30. The production process according to claim 28, wherein the at least one stabilizer is added before or during the polymerization of the at least one acrylamide polymer, where the monomer mixture comprises acrylamide, optionally one or more further monomers, the at least one stabilizer, and at least one solvent.

31. The production process according to claim 28, wherein the at least one stabilizer is added before or during the polymerization of the at least one acrylamide polymer, the polymerization being effected by means of adiabatic gel polymerization of an aqueous monomer solution comprising acrylamide; optionally one or more further monomers; 0.1 to 2% by weight, based on the total amount of the monomers in the monomer mixture, of the at least one stabilizer; and at least one solvent comprising at least 50% by weight of water, based on the overall solvent.

32. A process for mineral oil production comprising:
providing an aqueous formulation comprising at least one acrylamide polymer, which comprises at least 10% by weight of (meth)acrylamide, based on the total amount of all the monomers in acrylamide polymer, and at least one stabilizer of formula (I) 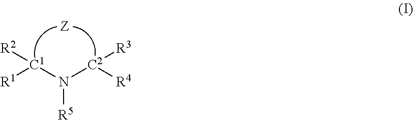
where:
Z is a bivalent group that optionally includes groups selected from C(R⁶)₂, O, S, N—R or C═O, where the Z group together with the carbon atoms C¹, C² and the nitrogen atom N forms a 5- to 8-membered ring, where R′ is selected from H, C₁₋₂₀-alkyl, C₂₋₂₀-alkenyl, C₆₋₂₀-aryl, C₇₋₃₂-arylalkyl, C₁₋₂₀-hydroxyalkyl, C₁₋₂₀-aminoalkyl, C₁₋₂₀-cyanoalkyl, C₁₋₂₀-halo alkyl, C₁₋₂₀-sulfoalkyl, or C₁₋₂₀-phosphonoalkyl;
where R⁶ is independently selected from: H; OH; CN; C₁₋₂₀-alkyl; C₂₋₂₀-alkenyl; C₂₋₂₀-alkynyl; C₆₋₂₀-aryl; C₇₋₃₂-arylalkyl; C₁₋₂₀-alkoxy; C₁₋₂₀-hydroxyalkyl; C₁₋₂₀-aminoalkyl; C₁₋₂₀-cyanoalkyl; C₁₋₂₀-haloalkyl; halogen; C₁₋₂₀-sulfoalkyl; C₁₋₂₀-phosphonoalkyl; —(CH₂—CH(R^{a})—O)_{q}—H with q=1-20 and R^{a}=H or C₁₋₆-alkyl; —O—C(═O)R^{b} with R^{b}=H, C₁₋₂₀-alkyl, C₂₋₂₀-alkenyl, C₂₋₂₀-alkynyl, C₆₋₂₀-aryl or C₇₋₃₂-arylalkyl; —O—C(═O)—(CH₂)ₘ—C(═O)—O—R^{c}; —O—C(═O)—Y—C(═O)—O—R^{c}, where m=1-10, R^{e}=H, C₁₋₂₀-alkyl, C₂₋₂₀-alkenyl, C₂₋₂₀-alkynyl, C₆₋₂₀-aryl, C₇₋₃₂-arylalkyl or 1,2,2,6,6-pentamethylpiperidin-4-yl and Y is a C₂₋₁₀-alkenylene group; —O—R^{d} with R^{d}=C₂₋₂₀-alkenyl, C₂₋₂₀-alkynyl, C₆₋₂₀-aryl, C₇₋₃₂-arylalkyl or 1,2,2,6,6-pentamethylpiperidin-4-yl; —NR^{x}R^{y}; —N(R^{x})—C(═O)R^{y}; —N(R^{x})—C(═O)—Y—C(═O)—O—R^{y}; —N(R^{x})—(CH₂), —NR^{y}R^{z} where R^{x}, R^{y} and R^{z} are each independently H, C₁₋₂₀-alkyl, C₂₋₂₀-alkenyl, C₂₋₂₀-alkynyl, C₆₋₂₀-aryl, C₇₋₃₂-arylalkyl, C₁₋₂₀-hydroxyalkyl, C₁₋₂₀-aminoalkyl or 1,2,2,6,6-pentamethylpiperidin-4-yl, r=1-10 and Y is a C₂₋₁₀-alkenylene group; —(O—CH₂—CH(R^{e})—(CH₂)ᵢ)ₚ—O—R^{e′} with p=1-20, i=0 or 1, R^{e}=H, OH or C₁₋₆-alkyl, and R^{e′}=H or C₁₋₈-alkyl; —S—R^{f}; —S—S—R^{f} with R^{f}=H, C₁₋₂₀-alkyl, C₂₋₂₀-alkenyl, C₆₋₂₀-aryl or C₇₋₃₂-arylalkyl;
or where two R⁶ radicals together with the carbon atom to which they are bonded form a —C—(O—CH₂—CH₂—O)—, —C—(O—CH₂—CH₂—CH₂—O), —C—(O—C(CH₃)₂—C(CH₃)₂—O)— or —C—(NH—C(═O)—NH—C(═O))— ring;
R¹, R², R³ and R⁴
are each independently selected from C₁₋₂₀-alkyl, C₂₋₂₀-alkenyl, C₆₋₂₀-aryl, C₇₋₃₂-arylalkyl, C₁₋₂₀-alkoxy, C₁₋₂₀-hydroxyalkyl, C₁₋₂₀-aminoalkyl or C₁₋₂₀-haloalkyl;
or the R¹ and R² radicals together with C¹, or the R³ and R⁴ radicals together with C², form a ring which comprises 5 to 7 carbon atoms and which may optionally be substituted by one or more R⁶ groups;
R⁵ is H; C₁₋₂₀-alkyl; C₂₋₂₀-alkenyl; C₂₋₂₀-alkynyl; C₆₋₂₀-aryl; C₇₋₃₂-arylalkyl; C₁₋₂₀-alkoxy; C₄₋₈-cycloalkoxy; C₁₋₂₀-hydroxyalkyl; C₁₋₂₀-aminoalkyl; C₁₋₂₀-cyanoalkyl; C₁₋₂₀-haloalkyl; C₁₋₂₉-sulfoalkyl; C₁₋₂₀-phosphonoalkyl; —(CH₂—CH(R^{a})—O)_{q}—H with q=1-20 and R^{a}=H or C₁₋₆-alkyl; —O—C(═O)R^{b} with R^{b}=H, C₁₋₂₀-alkyl, C₂₋₂₀-alkenyl, C₂₋₂₀-alkynyl, C₆₋₂₀-aryl or C₇₋₃₂-arylalkyl; —O—C(═O)—(CH₂)ₘ—C(═O)—O—R^{c}; —O—C(═O)—Y—C(═O)—O—R^{c}, where m=1-10, R^{c}=H, C₁₋₂₀-alkyl, C₂₋₂₀-alkenyl, C₂₋₂₀-alkynyl, C₆₋₂₀-aryl, C₇₋₃₂-arylalkyl or 1,2,2,6,6-pentamethylpiperidin-4-yl and Y is a C₂₋₁₀-alkenylene group; —O—R^{d} with R^{d}=C₂₋₂₀-alkenyl, C₂₋₂₀-alkynyl, C₆₋₂₀-aryl, C₇₋₃₂-arylalkyl or 1,2,2,6,6-pentamethylpiperidin-4-yl; —(O—CH₂—CH(R^{e})—(CH₂)ᵢ)ₚ—O—R^{e′} with p=1-20, i=0 or 1, R^{e}=H, OH or C₁₋₆-alkyl and R^{e′}=H or C₁₋₈-alkyl; —C(═O)—R^{h} with R^{h}=H, C₁₋₂₀-alkyl, C₂₋₂₀-alkenyl, C₆₋₂₀-aryl or C₇₋₂₀-arylalkyl; 2,2,6,6-tetramethyl-4-piperidinol-1-yl-alkyl or 4-(2,2,6,6-tetramethyl-4-piperidinol-1-ylalkyl)benzyl; and
injecting the aqueous formulation into an underground formation through at least one injection well; and
withdrawing the mineral oil from the underground formation through at least one production well.

33. The process according to claim 32, wherein the at least one acrylamide polymer is a copolymer comprising (meth)acrylamide and at least one anionic, monoethylenically unsaturated, hydrophilic monomer (b) comprising at least one acidic group selected from the group of —COON, —SO₃H and —PO₃H₂ or salts thereof.

34. The process according to claim 32, which is performed in the presence of oxygen.
